(19) United States
(12) Patent Application Publication
(10) Pub. No.: US 2023/0403752 A1
(43) Pub. Date: Dec. 14, 2023

(54) DISTRIBUTED ANTENNA PANELS FOR SIMULTANEOUS COMMUNICATION

(71) Applicant: QUALCOMM Incorporated, San Diego, CA (US)

(72) Inventors: Yan ZHOU, San Diego, CA (US); Qian ZHANG, Basking Ridge, NJ (US); Tao LUO, San Diego, CA (US); Aleksandar DAMNJANOVIC, Del Mar, CA (US)

(21) Appl. No.: 17/839,209

(22) Filed: Jun. 13, 2022

(51) Int. Cl. H04W 76/15; H04B 7/06; H04B 7/024; H04B 7/0426; H04W 72/04

(52) U.S. Cl. CPC H04W 76/15; H04B 7/0626; H04B 7/024; H04B 7/0426; H04W 72/046; H04W 72/042

(57) ABSTRACT

Aspects relate to communication using multiple antenna panels. A first user equipment (UE) may use an antenna panel of a second UE for receiving and/or transmitting data. For example, a network entity may schedule a transmission to the first UE where a first transmit receive point (TRP) transmits data to a first antenna panel of the first UE via a first TRP and simultaneously transmits data to a second antenna panel of the second UE via a second TRP, whereby the second UE forwards the data it receives to the first UE. The first UE may send antenna panel information to the network entity for scheduling a multi-panel transmission or reception for the first UE. The first UE may send a request to the second UE to forward data for a multi-panel transmission or reception.

### TECHNICAL FIELD

The technology discussed below relates generally to wireless communication and, more particularly, to using distributed antenna panels for simultaneous transmissions and/or receptions.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple wireless communication devices. For example, a base station may allocate different resources (e.g., time domain and frequency domain resources) for different wireless communication devices operating within a cell of the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first apparatus may include an interface and a processing system. The processing system may be configured to generate an indication of a first antenna panel and a second antenna panel that are available for a multi-panel communication with the first apparatus. In some examples, the first antenna panel is associated with the first apparatus and the second antenna panel is associated with a second apparatus. The processing system may also be configured to output the indication via the interface for transmission to a network entity. The processing system may further be configured to output, via the interface for transmission to the second apparatus, a request for the second apparatus to perform a forwarding operation between the first apparatus and the second antenna panel for the multi-panel communication.

In some examples, a method for communication at a first apparatus is disclosed. The method may include generating an indication of a first antenna panel and a second antenna panel that are available for a multi-panel communication with the first apparatus. In some examples, the first antenna panel is associated with the first apparatus and the second antenna panel is associated with a second apparatus. The method may also include outputting the indication for transmission to a network entity. The method may further include outputting, for transmission to the second apparatus, a request for the second apparatus to perform a forwarding operation between the first apparatus and the second antenna panel for the multi-panel communication.

In some examples, a first apparatus may include means for generating an indication of a first antenna panel and a second antenna panel that are available for a multi-panel communication with the first apparatus. In some examples, the first antenna panel is associated with the first apparatus and the second antenna panel is associated with a second apparatus. The first apparatus may also include means for outputting the indication for transmission to a network entity. The first apparatus may further include means for outputting, for transmission to the second apparatus, a request for the second apparatus to perform a forwarding operation between the first apparatus and the second antenna panel for the multi-panel communication.

In some examples, a non-transitory computer-readable medium has stored therein instructions executable by a processing system of a first apparatus to generate an indication of a first antenna panel and a second antenna panel that are available for a multi-panel communication with the first apparatus. In some examples, the first antenna panel is associated with the first apparatus and the second antenna panel is associated with a second apparatus. The computer-readable medium may also have stored therein instructions executable by the processing system of the first apparatus to output the indication for transmission to a network entity. The computer-readable medium may further have stored therein instructions executable by the processing system of the first apparatus to output, for transmission to the second apparatus, a request for the second apparatus to perform a forwarding operation between the first apparatus and the second antenna panel for the multi-panel communication.

In some examples, a first apparatus may include an interface and a processing system. The processing system may be configured to obtain, via the interface, an indication of a first antenna panel and a second antenna panel that are available for a multi-panel communication with a first user equipment. In some examples, the first antenna panel is associated with the first user equipment and the second antenna panel is associated with a second user equipment. The processing system may also be configured to communicate, via the interface, first data and second data for the multi-panel communication. In some examples, the first data is communicated between the first antenna panel and a first transmit receive point. In some examples, the second data is communicated between the second antenna panel and a second transmit receive point.

In some examples, a method for communication at a first apparatus is disclosed. The method may include obtaining an indication of a first antenna panel and a second antenna panel that are available for a multi-panel communication with a first user equipment. In some examples, the first antenna panel is associated with the first user equipment and the second antenna panel is associated with a second user equipment. The method may also include communicating first data and second data for the multi-panel communication. In some examples, the first data is communicated between the first antenna panel and a first transmit receive point. In some examples, the second data is communicated between the second antenna panel and a second transmit receive point.

In some examples, a first apparatus may include means for obtaining an indication of a first antenna panel and a second antenna panel that are available for a multi-panel communication with a first user equipment. In some examples, the first antenna panel is associated with the first user equipment and the second antenna panel is associated with a second user equipment. The first apparatus may also include means for communicating first data and second data for the multi-panel communication. In some examples, the first data is communicated between the first antenna panel and a first transmit receive point. In some examples, the second data is communicated between the second antenna panel and a second transmit receive point.

In some examples, a non-transitory computer-readable medium has stored therein instructions executable by a processing system of a first apparatus to obtain an indication of a first antenna panel and a second antenna panel that are available for a multi-panel communication with a first user equipment. In some examples, the first antenna panel is associated with the first user equipment and the second antenna panel is associated with a second user equipment. The computer-readable medium may also have stored therein instructions executable by the processing system of the first apparatus to communicate first data and second data for the multi-panel communication. In some examples, the first data is communicated between the first antenna panel and a first transmit receive point. In some examples, the second data is communicated between the second antenna panel and a second transmit receive point.

These and other aspects of the disclosure will become more fully understood upon a review of the detailed description, which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a diagram illustrating an example of a wireless communication network employing sidelink communication according to some aspects.

FIG. 6 is a schematic illustration of an example of an apparatus for communication according to some aspects.

FIG. 7 is a schematic illustration of an example of an apparatus (e.g., a user equipment) with multiple antenna panels according to some aspects.

FIG. 8 is a schematic illustration of an example of a wireless communication system including distributed antenna panels according to some aspects.

FIG. 9 is a conceptual illustration of examples of slot timing for multi-panel communication according to some aspects.

FIG. 10 is a signaling diagram illustrating an example of signaling the availability of antenna panels for multi-panel communication according to some aspects.

FIG. 11 is a signaling diagram illustrating an example of multi-panel communication based on a time gap according to some aspects.

FIG. 12 is a signaling diagram illustrating another example of multi-panel communication based on a time gap according to some aspects.

FIG. 13 is a block diagram conceptually illustrating an example of a hardware implementation for an apparatus (e.g., a user equipment) employing a processing system according to some aspects.

FIG. 14 is a flow chart illustrating an example wireless communication method relating to outputting an indication of antenna panels that are available for multi-panel communication according to some aspects.

FIG. 15 is a block diagram conceptually illustrating an example of a hardware implementation for an apparatus (e.g., a network entity) employing a processing system according to some aspects.

FIG. 16 is a flow chart illustrating an example wireless communication method relating to obtaining an indication of antenna panels that are available for multi-panel communication according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to distributed antenna panels. A user equipment (UE) may incorporate one or more antenna panels for transmitting data to and receiving data from one or more network entities (e.g., base stations). In some examples, the quantity of antenna panels at a UE may not be sufficient to provide a desired level of service (e.g., throughput, bandwidth, etc.) at the UE.

The disclosure relates in some aspects to a first UE using at least one antenna panel of a second UE for receiving and/or transmitting data. For example, a network entity may schedule a simultaneous transmission to the first UE where a first transmit receive point (TRP) transmits data to a first antenna panel of the first UE and a second TRP simultaneously transmits data (e.g., the same data) to a second antenna panel of the second UE. In this case, the second UE forwards the data it receives from the second TRP to the first UE (e.g., via a sidelink channel).

In some examples, the first UE sends capability information to the network entity that the network entity uses to schedule a multi-panel transmission or reception for the first UE. In some examples, the capability information identifies at least one antenna panel of the second UE that can be used for the multi-panel transmission or reception.

In some examples, the first UE sends a request to the second UE to forward data for a multi-panel transmission or reception. For example, the first UE may send a message via a sidelink channel that requests the second UE to forward to the first UE, via the sidelink channel, data that the second UE received via the second TRP.

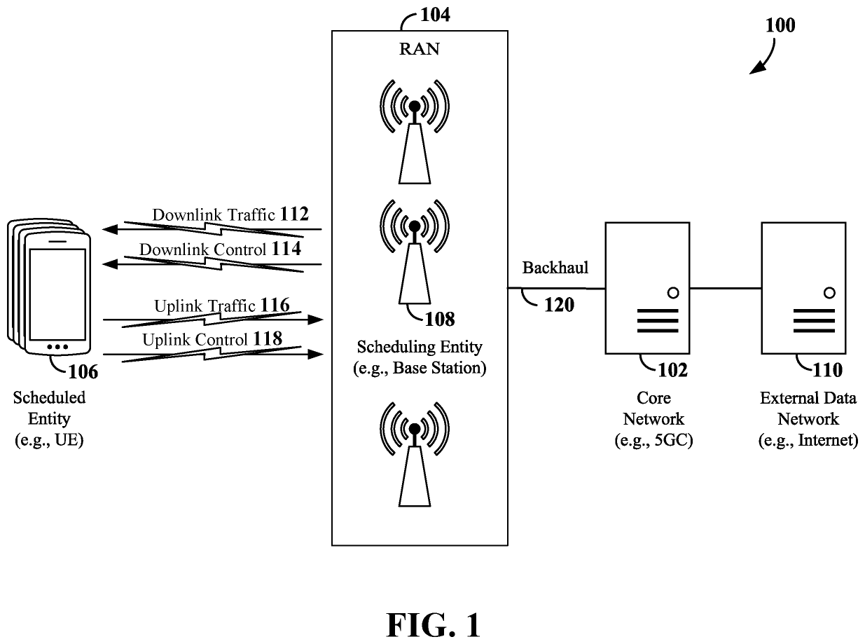

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) or some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

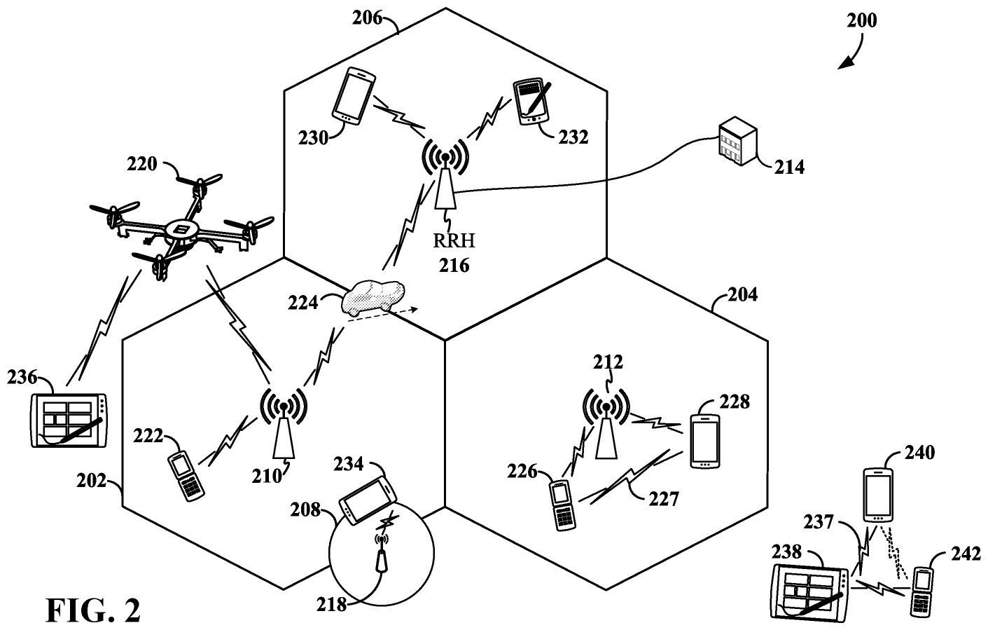

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

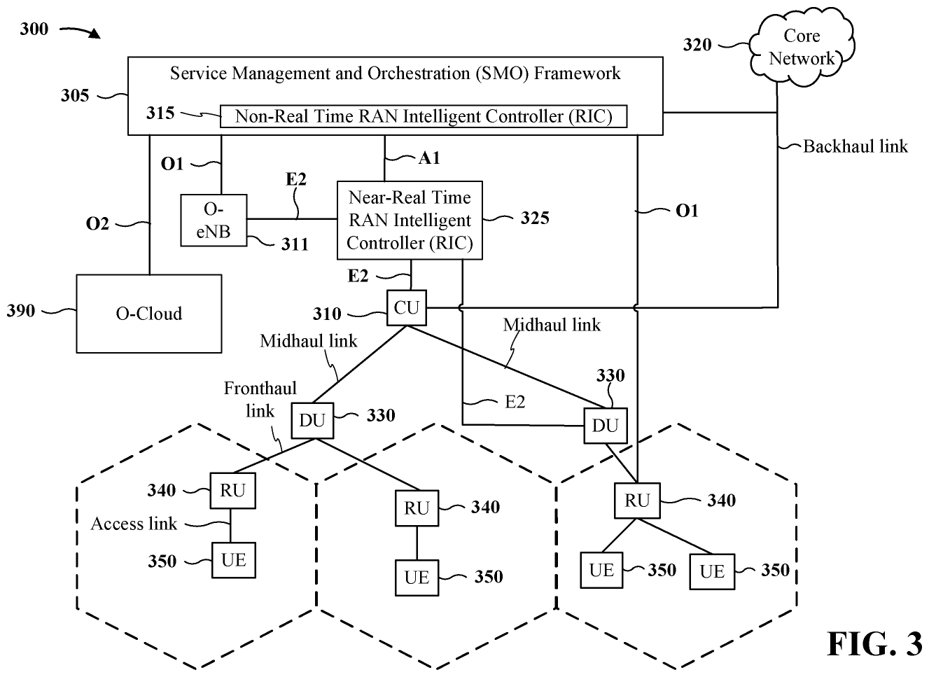

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

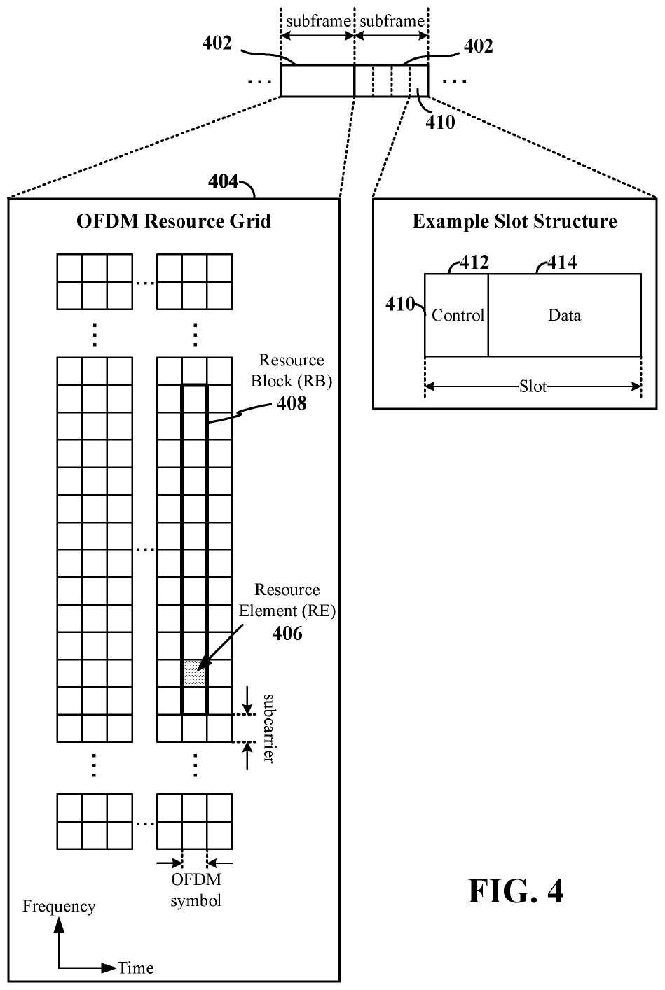

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

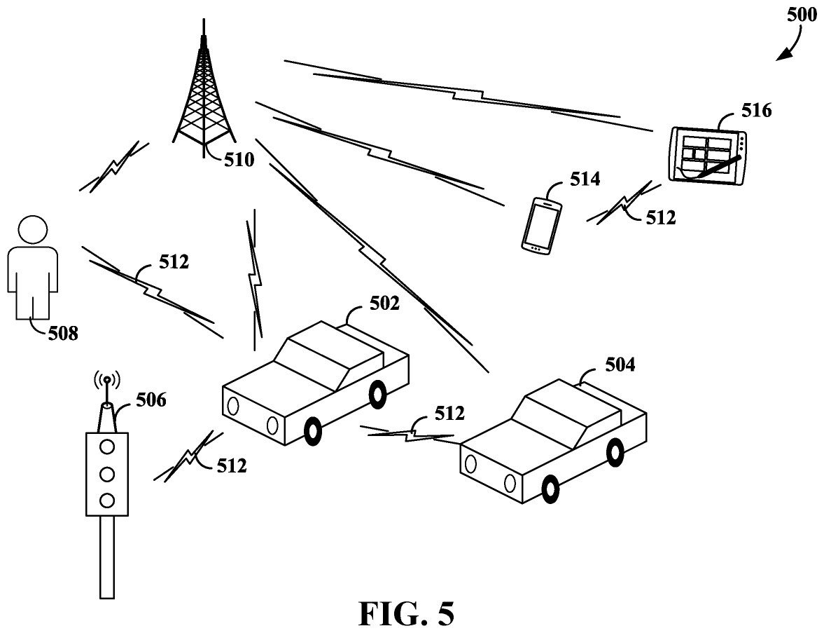

FIG. 5 illustrates an example of a wireless communication network 500 configured to support sidelink communication. In some examples, sidelink communication may include V2X communication. V2X communication involves the wireless exchange of information directly between not only vehicles (e.g., vehicles 502 and 504) themselves, but also directly between vehicles 502 and 504 and infrastructure (e.g., a roadside unit (RSU) 506), such as streetlights, buildings, traffic cameras, tollbooths or other stationary objects, between vehicles 502 and 504 and pedestrians 508 (e.g., including cyclists, etc.), and between vehicles 502 and 504 and wireless communication networks (e.g., base station 510). In some examples, V2X communication may be implemented in accordance with the New Radio (NR) cellular V2X standard defined by 3GPP, Release 16, or other suitable standard.

V2X communication enables vehicles 502 and 504 to obtain information related to the weather, nearby accidents, road conditions, activities of nearby vehicles and pedestrians, objects nearby the vehicle, and other pertinent information that may be utilized to improve the vehicle driving experience and increase vehicle safety. In some examples, such V2X data may enable autonomous driving, improve road safety, and improve traffic efficiency. For example, the exchanged V2X data may be utilized by a V2X connected vehicle 502 and 504 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian 508 may be utilized to trigger a warning sound, vibration, flashing light, etc., in case of imminent danger.

The sidelink communication between vehicle-UEs (V-UEs) (e.g., corresponding to the vehicles 502 and 504) or between a V-UE and either an RSU 506 or a pedestrian-UE (P-UE) (e.g., corresponding to the pedestrian 508) may occur over a sidelink 512 utilizing a proximity service (ProSe) PC5 interface. In various aspects of the disclosure, the PC5 interface may further be utilized to support D2D sidelink 512 communication in other proximity use cases. Examples of other proximity use cases may include public safety or commercial (e.g., entertainment, education, office, medical, and/or interactive) based proximity services. In the example shown in FIG. 5, ProSe communication may further occur between UEs 514 and 516.

ProSe communication may support different operational scenarios, such as in-coverage, out-of-coverage, and partial coverage. Out-of-coverage refers to a scenario in which UEs (e.g., V-UEs corresponding to the vehicles 502 and 504, and P-UEs corresponding to pedestrians 508) are outside of the coverage area of a base station (e.g., base station 510), but each are still configured for ProSe communication. Partial coverage refers to a scenario in which some of the UEs (e.g., a V-UE correspond to the vehicle 504) are outside of the coverage area of the base station 510, while other UEs (e.g., a V-UE correspond to the vehicle 502, and P-UEs corresponding to pedestrians 508) are in communication with the base station 510. In-coverage refers to a scenario in which UEs (e.g., UEs 514 and 516) are in communication with the base station 510 (e.g., gNB) via a Uu (e.g., cellular interface) connection to receive ProSe service authorization and provisioning information to support ProSe operations.

To facilitate D2D sidelink communication between, for example, UEs 514 and 516 over the sidelink 512, the UEs 514 and 516 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 512. For example, the discovery signal may be utilized by the UE 516 to measure the signal strength and channel status of a potential sidelink (e.g., sidelink 512) with another UE (e.g., UE 514). The UE 516 may utilize the measurement results to select a UE (e.g., UE 514) for sidelink communication or relay communication.

In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a base station (e.g., base station 510).

In addition, there may be two main resource allocation modes of operation for sidelink (e.g., PC5) communications. In a first mode, Mode 1, a base station (e.g., gNB) 510 may allocate resources to sidelink devices (e.g., V2X devices or other sidelink devices) for sidelink communication between the sidelink devices in various manners. For example, the base station 510 may allocate sidelink resources dynamically (e.g., a dynamic grant) to sidelink devices, in response to requests for sidelink resources from the sidelink devices. For example, the base station 510 may schedule the sidelink communication via DCI 2_0. In some examples, the base station 510 may schedule the PSCCH/PSSCH within uplink resources indicated in DCI 2_0. The base station 510 may further activate preconfigured sidelink grants (e.g., configured grants) for sidelink communication among the sidelink devices. In some examples, the base station 510 may activate a configured grant (CG) via RRC signaling. In Mode 1, sidelink feedback may be reported back to the base station 510 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may be transmitted within the PSSCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

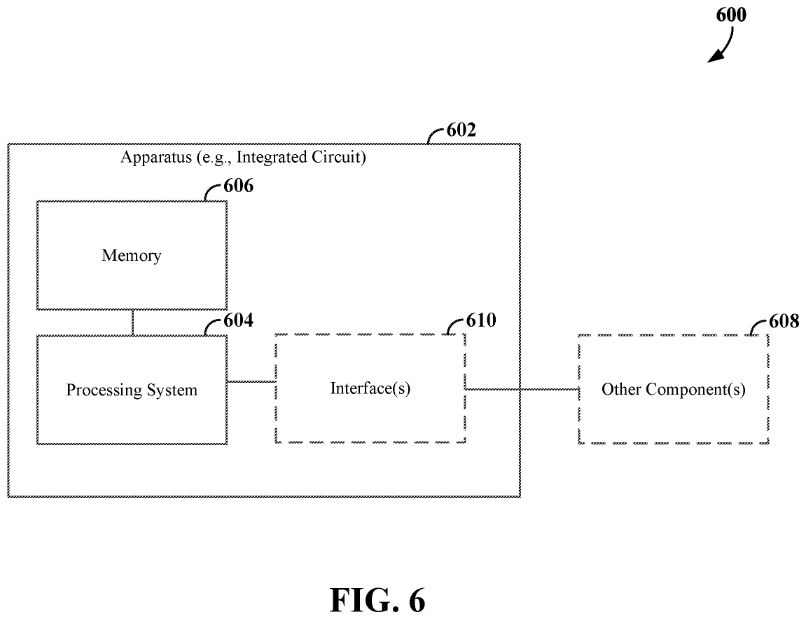

FIG. 6 illustrates an example apparatus 600 according to certain aspects of the disclosure. In some examples, the apparatus 600 may be configured as a network entity (e.g., a base station), a UE, or some other type of wireless node (e.g., a wireless communication device including a transmitter and/or a receiver). In some examples, the apparatus 600 may correspond to any of the apparatuses, UEs, scheduled entities, base stations (e.g., gNBs), scheduling entities, DUs, CUs, RUs, RAN nodes, or CN entities shown in any of FIGS. 1-3, 5, 7, 8, 10-13, and 15.

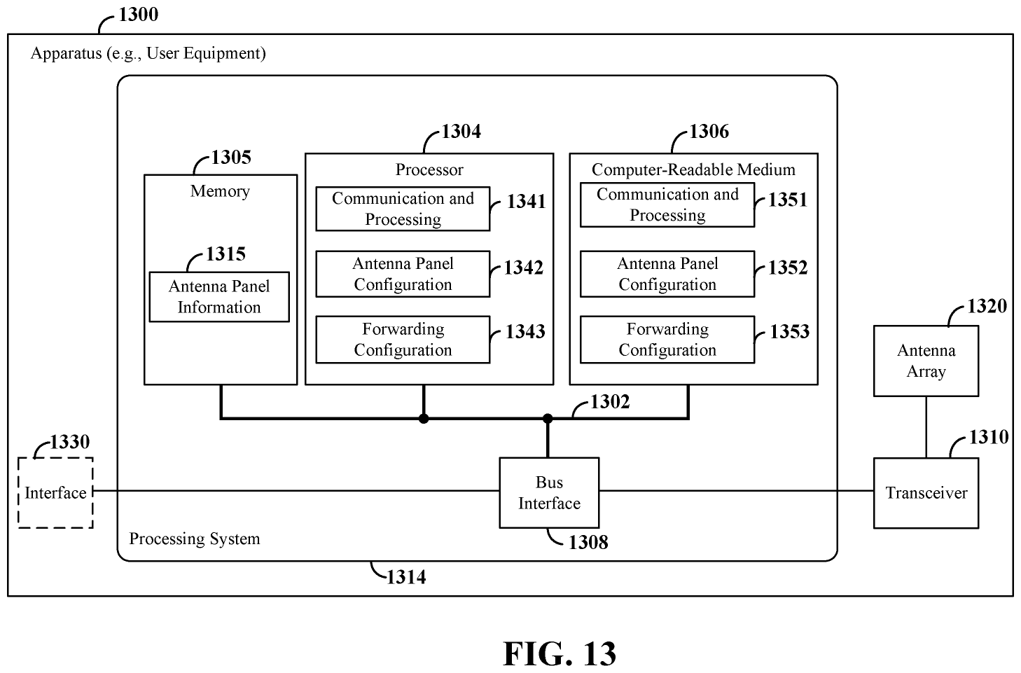

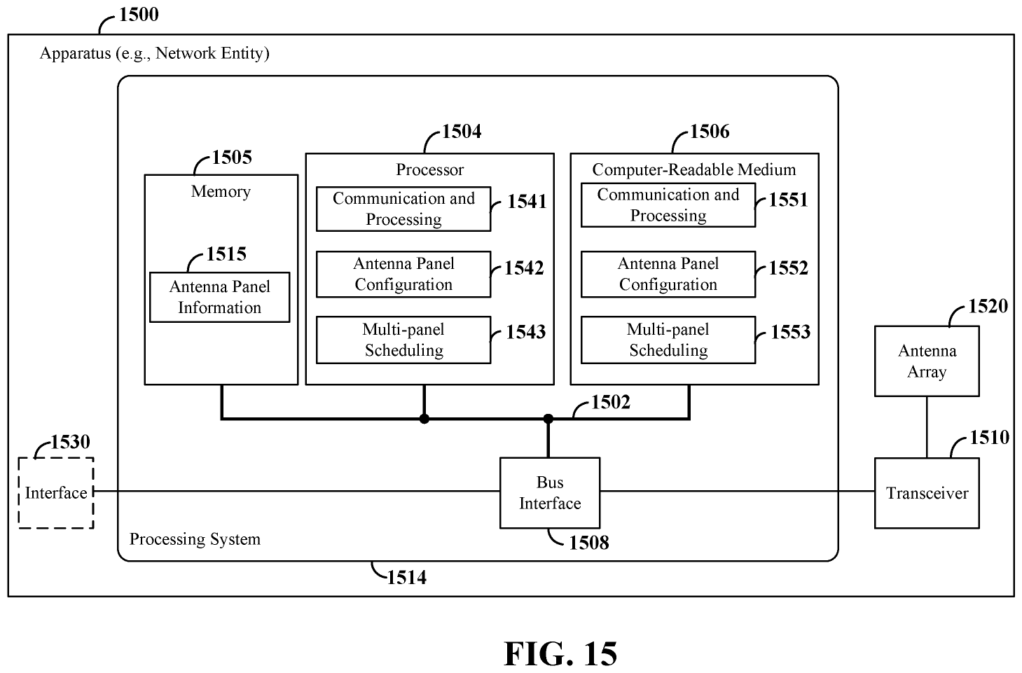

The apparatus 600 includes an apparatus 602 (e.g., an integrated circuit) and, optionally, at least one other component 608. In some aspects, the apparatus 602 may be configured to operate in a wireless communication device (e.g., a UE, a BS, etc.) and to perform one or more of the operations described herein. The apparatus 602 includes a processing system 604, and a memory 606 coupled to the processing system 604. Example implementations of the processing system 604 are provided herein. In some examples, the processing system 604 of FIG. 6 may correspond to the processing system 1314 of FIG. 13. In some examples, the processing system 604 of FIG. 6 may correspond to the processing system 1514 of FIG. 15.

The processing system 604 is generally adapted for processing, including the execution of such programming stored on the memory 606. For example, the memory 606 may store instructions that, when executed by the processing system 604, cause the processing system 604 to perform one or more of the operations described herein.

In some implementations, the apparatus 602 communicates with at least one other component (e.g., a component 608 external to the apparatus 602) of the apparatus 600. To this end, in some implementations, the apparatus 602 may include at least one interface 610 (e.g., a send and/or receive interface) coupled to the processing system 604 for outputting and/or obtaining (e.g., sending and/or receiving) information (e.g., received information, generated information, decoded information, messages, etc.) between the processing system 604 and the other component(s) 608. In some implementations, the interface 610 may include an interface bus, bus drivers, bus receivers, buffers, other suitable circuitry, or a combination thereof. In some implementations, the interface 610 may include radio frequency (RF) circuitry (e.g., an RF transmitter and/or an RF receiver). In some implementations, the interface 610 may be configured to interface the apparatus 602 to one or more other components of the apparatus 600 (other components not shown in FIG. 6). For example, the interface 610 may be configured to interface the processing system 604 to a radio frequency (RF) front end (e.g., an RF transmitter and/or am RF receiver).

The apparatus 602 may communicate with other apparatuses in various ways. In cases where the apparatus 602 includes an RF transceiver (not shown in FIG. 6), the apparatus may transmit and receive information (e.g., a frame, a message, bits, etc.) via RF signaling. In some cases, rather than transmitting information via RF signaling, the apparatus 602 may have an interface to provide (e.g., output, send, transmit, etc.) information for RF transmission. For example, the processing system 604 may output information, via a bus interface, to an RF front end for RF transmission. Similarly, rather than receiving information via RF signaling, the apparatus 602 may have an interface to obtain information that is received by another apparatus. For example, the processing system 604 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

The apparatus 602 may perform various processing (e.g., encoding, modulation, etc.) operations in conjunction with transmitting a transmission. In addition, the apparatus 602 may perform various processing (e.g., decoding, demodulation, etc.) operations in conjunction with receiving a transmission.

As mentioned above, an apparatus may use one or more antenna ports for a transmission. In some examples, an antenna port is a logical entity used to map data streams to one or more antennas. Each antenna port may be associated with a reference signal (e.g., which may allow a receiver to distinguish data streams associated with the different antenna ports in a received transmission). For example, logical antenna ports 1000-1999 may be used for SRS transmissions in some networks. An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from MIMO layers may be combined and re-distributed to each of the antenna ports, then precoding is applied, and the precoded data symbols are applied to corresponding REs for OFDM signal generation and transmission via one or more physical antenna elements.

In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

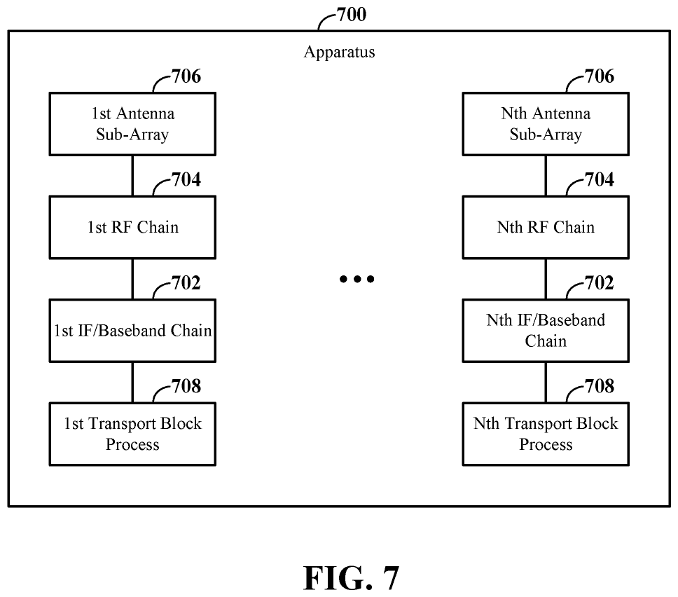

FIG. 7 illustrates an apparatus 700 (e.g., a UE, etc.) that includes multiple antenna panels (e.g., antenna sub-arrays). In some examples, the apparatus 700 may correspond to any of the apparatuses, UEs, scheduled entities, base stations (e.g., gNBs), scheduling entities, distributed units, control units, RAN nodes, or CN entities shown in any of FIGS. 1-3, 5, 6, 8, 10-13, and 15.

The apparatus 700 has “N” intermediate frequency (IF)/baseband chains 702. N could be 2 or more. Each IF chain can be connected to multiple RF chains 704 (M). M may be one or more. Each RF chain may connect to at least one antenna sub-array (or some other of antenna element(s)) 706. Thus, each IF/baseband chain 702 (e.g., used for a corresponding transport block process 708) can be connected to different antenna sub-arrays of the apparatus 700.

Multiple sub-arrays may be used to cover different beam directions. In some examples, rank 2 reception (e.g., two MIMO layers) at the apparatus 700 may be achieved by dual polarization at one sub-array (e.g., a patch antenna). In some implementations, rank 2 reception at the apparatus 700 may be achieved by {H,H}, {V,V}, {H,V}, {V,H}polarization where the H (horizontal) or V (vertical) polarizations are at different sub-arrays (e.g., dipole antennas). Other antenna configurations may be used in other examples.

In some examples, the quantity of antenna panels at a UE may not be sufficient to provide a desired level of service (e.g., throughput, bandwidth, etc.) at the UE. The disclosure relates in some aspects to distributed UE panel operation where a first UE uses at least one antenna panel of a second UE for receiving and/or transmitting data. For example, a first UE (UE 1) may use an antenna panel of a neighbor UE (UE 2) to improve throughput or reliability. As one example, in a scenario where UE 1 can receive downlink (DL) data from a first TRP (TRP 1) but not a second TRP (TRP 2), to improve throughput, UE 1 may request UE 2 to simultaneously receive DL data from TRP 2. In this case, UE 2 may relay the DL data received from TRP 2 to UE 1 (e.g., via a sidelink channel). In some aspects, the distributed UE panel operation may be transparent to the serving base station (e.g., a gNB). For example, UE 1 may report that two antenna panels are available for simultaneous DL reception, and the base station may not need to know whether the antenna panels are physically on UE 1 or not.

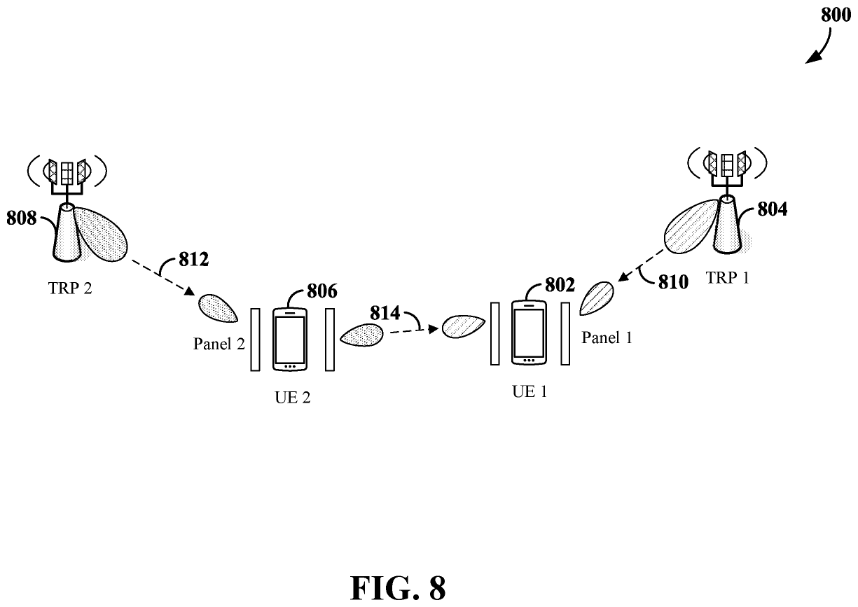

FIG. 8 illustrates an example of a wireless communication system 800 that includes a first UE 802 (UE 1) that communicates with a first TRP 804 (TRP 1) and a second UE 806 (UE 2) that communicates with a second TRP 808 (TRP 2). In some examples, the first UE 802 and the second UE 806 may correspond to any of the UEs or scheduled entities shown in any of FIGS. 1-3, 5-7, and 9-13. In some examples, the first TRP 804 and the second TRP 808 may correspond to any of the network entities, base stations, CUs, DU, RUs, or scheduling entities shown in any of FIGS. 1-3, 5-7, 11-12, and 15.

During a multi-panel downlink transmission (e.g., a simultaneous downlink transmission) to the first UE 802, the first TRP 804 transmits data to panel 1 of the first UE 802 via a downlink transmission 810 and the second TRP 808 transmits data to panel 2 of the second UE 806 via a downlink transmission 812. In addition, the second UE 806 forwards the data it receives from the second TRP 808 to the first UE 802 via a sidelink transmission 814.

During a multi-panel uplink transmission (e.g., a simultaneous uplink transmission, not shown in FIG. 8) from the first UE 802, the first UE 802 uses panel 1 to transmit data to the first TRP 804 via an uplink transmission. In addition, the first UE 802 transmits data to the second UE 806 via a sidelink transmission. The second UE 806 then uses panel 2 to forward this data to the second TRP 808 via an uplink transmission.

The disclosure relates in some aspects to assisting distributed UE panel operation by providing certain UE assistance information to a network entity (e.g., a base station). Several examples of this information follow.

In some examples, the UE assistance information includes dynamically updated UE panel information (e.g., the quantity and configuration of borrowed neighbor UE's panels). This information may enable a network entity (e.g., a base station) to determine whether a new UE panel is available for use.

In some examples, the UE assistance information indicates which UE panels can simultaneously receive (Rx) or transmit (Tx). For example, some panels on the same physical UE may share the same digital ports/chains and, hence, cannot simultaneously Rx/Tx. Conversely, panels on different physical UEs typically have independent digital ports/chains and, hence, can simultaneously Rx/Tx.

In some examples, the UE assistance information indicates a special time gap between two transmissions in the same or different directions to/from a network entity. For example, if UE 1 receives DCI on its own panel 1 and the DCI schedules DL or UL data on panel 2 of UE 2, a longer scheduling offset between the DCI and the scheduled data may be needed for UE 1 to inform UE 2 of the DL or UL grant. As another example, if DL data is received on panel 2 of UE 2 but the corresponding UL ACK/NACK (A/N) is to be transmitted on panel 1 of UE 1, a longer offset between the DL data and the UL A/N may be needed for UE 2 to inform UE 1 of the decoding results.

The disclosure relates in some aspects to assisting distributed UE panel operation by dynamically updating a UE's panel information to include information about borrowed neighbor UE's panels. The information may include new or deleted panel IDs, which account for the neighbor UE's panels that the UE will or will not use for multi-panel communication. For each new panel ID, the following information may be provided: (1) whether the panel is capable of DL only, UL only, or both DL and UL processing; (2) for a panel capable of DL processing the information may include the maximum number of MIMO layers in the DL including the maximum number of DMRS ports, and the maximum number of CSI-RS ports per CSI-RS resource for CSF; (3) the maximum number of candidate analog beams in the DL which determines the required number of CSI-RS resource repetitions in P3 (narrow beam) beam management (BM); (4) for a panel capable of UL processing the maximum number of antenna ports which determines the maximum number of MIMO layers in the UL; and (5) the maximum number of candidate analog beams in the UL.

In some examples, the panel information may indicate which set of panels cannot be used for simultaneous Rx and/or Tx (e.g., due to sharing the same baseband processing chain). For example, panel 1, 2, and 3 on UE 1 might not be able to simultaneously Rx since they share the same digital ports/chain. However, panel 1 on UE 1 and panel 4 on UE 2 may be able to simultaneously Rx since they have independent digital ports/chains on different physical UEs.

In some examples, the panel information may indicate a minimum time gap between two transmissions in the same or different directions to a network entity (e.g., the two transmissions (1^{st} and 2^{nd} transmissions) can be both DL, both UL, or DL and UL). In some examples, the minimum time gap can be between a DCI and a DL/UL Tx scheduled by the DCI (e.g., the parameter K0 or K2). In some examples, the minimum time gap can be between DL data and the corresponding UL A/N (e.g., the parameter K1). In some examples, the minimum time gap can also be a function of the panel IDs associated with the 1^{st} and 2^{nd} transmissions. For example, a longer time gap may be needed if the two transmissions are processed on panels of different physical UEs due to additional inter-UE communications, as examples in motivation.

Unlike UE capability, which is static and may only be reported once, the UE can dynamically update the panel information (e.g., via UCI, MAC-CE, or RRC). UCI can be sent on PUCCH/PUSCH, which may multiplex other UCI types or UL data. MAC-CE may be sent on a known UL grant, or an UL grant requested via a scheduling request (SR).

In various examples, multi-panel communication may occur during the same time slot or during different time slots. For example, in scenarios where the forwarding UE (e.g., UE 2) supports a fast relaying capability (e.g., an analog amplify and forward capability), the multi-panel communication may occur during the same time slot. As another example, in scenarios where the forwarding UE (e.g., UE 2) supports a slower relaying capability (e.g., a decode and forward capability), the multi-panel communication may occur during different time slots.

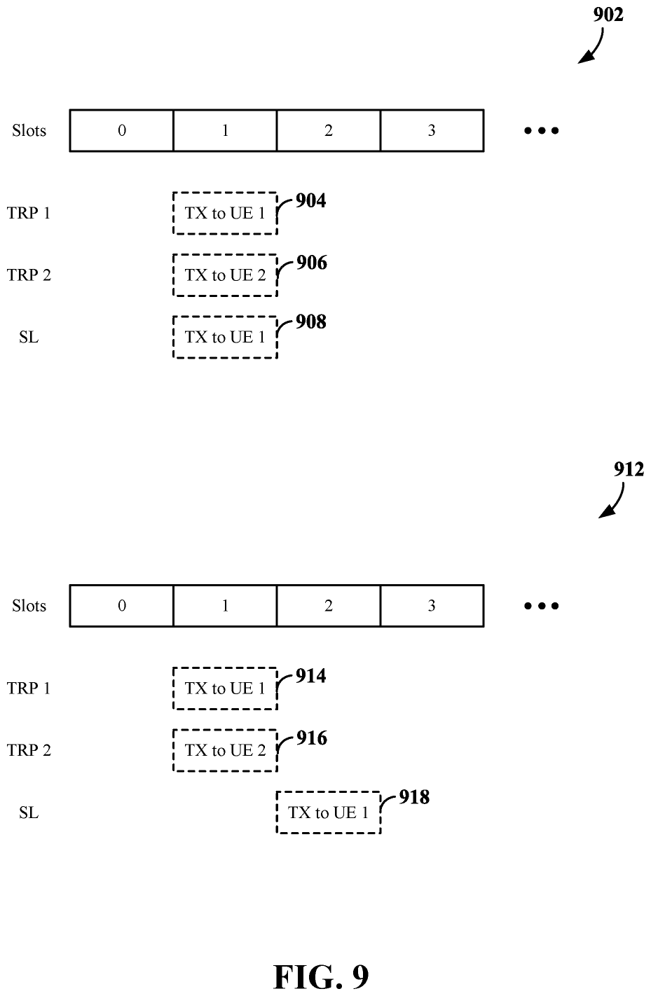

FIG. 9 illustrates two examples of these scenarios. In a first example 902 (e.g., where UE 2 supports a fast relaying capability), TRP 1 transmits first to UE 1 during time slot 1 at #904, TRP 2 transmits second data to UE 2 during time slot 1 at #906, and UE 2 forwards the second data received from TRP 2 to UE 1 via a sidelink channel during time slot 1 at #908. In a second example 912 (e.g., where UE 2 supports a slower relaying capability), TRP 1 transmits first data to UE 1 during time slot 1 at #914, TRP 2 transmits second data to UE 2 during time slot 1 at #916, and UE 2 forwards the second data received from TRP 2 to UE 1 via a sidelink channel during time slot 2 at #918. Other relay timing may be employed in other examples.

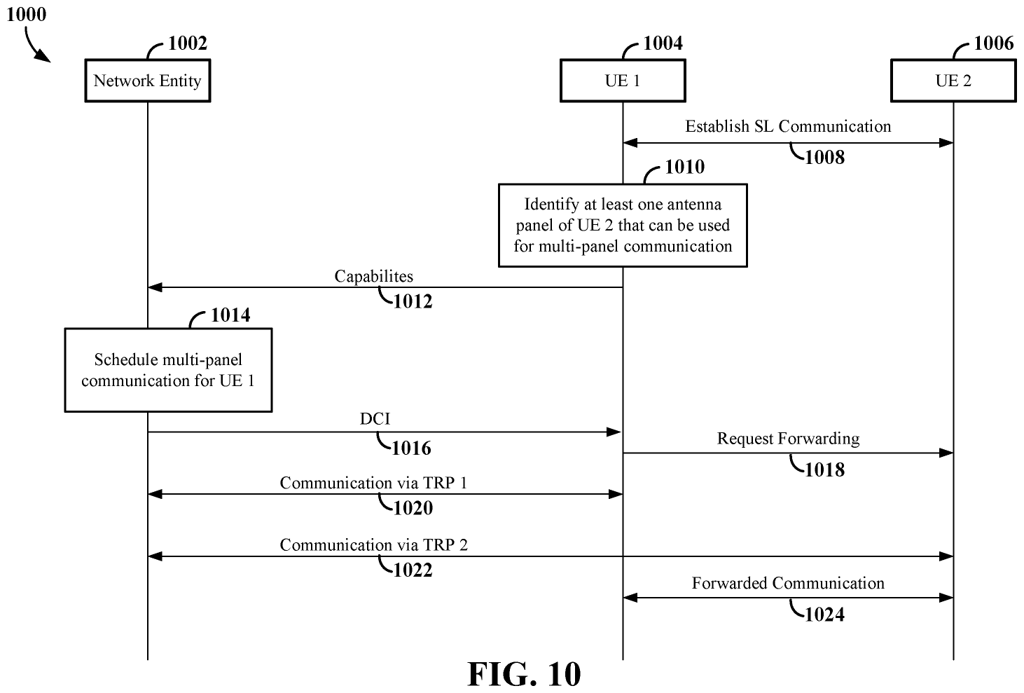

FIG. 10 is a signaling diagram 1000 illustrating an example of the signaling of antenna panel information in a wireless communication system including a network entity 1002 (e.g., a base station), a user equipment 1004 (UE 1), and a user equipment 1006 (UE 2). In some examples, the network entity 1002 may correspond to any of the network entities, base stations, CUs, DU, RUs, or scheduling entities shown in any of FIGS. 1-3, 5-8, 11-12, and 15. In some examples, the user equipment 1004 and the user equipment 1006 may correspond to any of the UEs or scheduled entities shown in any of FIGS. 1-3, 5-8, and 11-13.

At #1008 of FIG. 10, the user equipment 1004 and the user equipment 1006 establish sidelink communication. For example, the user equipment 1004 and the user equipment 1006 may perform sidelink discovery and other related operations as described above.

At #1010, the user equipment 1004 may identify one or more antenna panels of the user equipment 1006 that the user equipment 1004 may use for multi-panel communication. For example, the user equipment 1004 may determine an identifier of such an antenna panel and other configuration information (e.g., a beam index, a panel index, an ID of the user equipment 1006, etc.). In some examples, the user equipment 1004 may receive this information via a sidelink message from the user equipment 1006 (e.g., in response to a request from the user equipment 1004).

At #1012, the user equipment 1004 advertises its capabilities. For example, the user equipment 1004 may transmit a capabilities message that indicates the antenna panels that are available for a multi-panel transmission to the user equipment 1004 and/or the antenna panels that are available for a multi-panel reception from the user equipment 1004. For example, a set of antenna panels where one antenna panel is on the user equipment 1104 and another antenna panel is on the user equipment 1006 may be indicated as being available for simultaneous communication. As another example, a set of antenna panels on the user equipment 1104 that share digital ports, a transmit chain, or a receive chain, may be indicated as not being available for simultaneous communication, while antenna panels on the user equipment 1104 that do not share digital ports, a transmit chain, or a receive chain, may be indicated as being available for simultaneous communication. In some examples (e.g., as the antenna panel information changes), the user equipment 1004 may sent this information via uplink control information (UCI), a MAC-CE, or an RRC message.

At #1014, the network entity 1002 schedules a multi-panel communication for the user equipment 1004. For example, the network entity 1002 may configure a first TRP (TRP 1) to communicate with a first antenna panel of the user equipment 1004 and configure a second TRP (TRP 2) to communicate with a second antenna panel of the user equipment 1006.

At #1016, the network entity 1002 transmits a DCI for the multi-panel communication. As discussed herein, the DCI may include scheduling information (e.g., time slot resources, bandwidth resources, MCS, etc.) for the multi-panel communication, along with information (e.g., beam information) relating to the antenna panels and/or TRPs to be used for the communication.

At #1018, the user equipment 1004 sends a message to the user equipment 1006 that requests the user equipment 1006 to perform a forwarding operation in conjunction with the multi-panel communication indicated by the DCI of #1016. For example, the user equipment 1004 may request that the user equipment 1006 forward to the user equipment 1004 any data received via the second antenna panel of the user equipment 1006 during a designated time slot. As another example, the user equipment 1004 may request that the user equipment 1006 forward via the second antenna panel any data received from the user equipment 1004 during a designated time slot.

At #1020, the network entity 1002 and the user equipment 1004 conduct a communication (e.g., a downlink transmission or an uplink transmission) via the first TRP. In addition, at #1022, the network entity 1002 and the user equipment 1006 conduct a communication (e.g., a downlink transmission or an uplink transmission) via the second TRP. Furthermore, at #1024, the user equipment 1006 forwards the information for the communication at #1022 to or from the user equipment 1004.

As discussed above, the multi-panel communication may involve a downlink transmission, an uplink transmission, or a full-duplex communication. In examples where the multi-panel communication involves a downlink transmission, the communication at #1020 may be a downlink transmission from TRP 1 to the user equipment 1004, the communication at #1022 may be a downlink transmission from TRP 2 to the user equipment 1006, and the communication at #1024 may be a sidelink transmission from the user equipment 1006 to the user equipment 1004. In examples where the multi-panel communication involves an uplink transmission, the communication at #1020 may be an uplink transmission from the user equipment 1004 to TRP 1, the communication at #1024 may be a sidelink transmission from the user equipment 1004 to the user equipment 1006, and the communication at #1022 may be an uplink transmission from the user equipment 1006 to TRP 2. In some examples where the multi-panel communication involves a full-duplex communication, the communication at #1020 may be a downlink transmission from TRP 1 to the user equipment 1004, the communication at #1024 may be a sidelink transmission from the user equipment 1004 to the user equipment 1006, and the communication at #1022 may be an uplink transmission from the user equipment 1006 to TRP 2. In some examples where the multi-panel communication involves a full-duplex communication, the communication at #1020 may be an uplink transmission from the user equipment 1004 to TRP 1, the communication at #1022 may be a downlink transmission from TRP 2 to the user equipment 1006, and the communication at #1024 may be a sidelink transmission from the user equipment 1006 to the user equipment 1004.

As discussed above, in various examples, the communication of #1020, #1022, and 1024 may occur during the same time slot or different time slots. For example, in scenarios where the user equipment 1006 supports a relatively fast relaying capability (e.g., an analog amplify and forward capability), the communication of #1020, #1022, and 1024 may occur during the same time slot. As another example, in scenarios where the user equipment 1006 supports a slower relaying capability (e.g., a decode and forward capability), downlink transmissions at #1020 and #1022 may occur during the same time slot, while a sidelink transmission at #1024 may occur during a later time slot. As yet another example, in scenarios where the user equipment 1006 supports a slower relaying capability (e.g., a decode and forward capability), an uplink transmission at #1020 and a sidelink transmission at #1024 may occur during the same time slot, while an uplink transmission at #1022 may occur during a later time slot.

As a further example (e.g., where a full-duplex communication occurs at the user equipment 1004), in scenarios where the user equipment 1006 supports a slower relaying capability (e.g., a decode and forward capability), a downlink transmission at #1022 may occur during a first time slot, while an uplink transmission at #1020 and a sidelink transmission at #1024 may occur during a later time slot. Similarly, in scenarios where the user equipment 1006 supports a slower relaying capability (e.g., a decode and forward capability), an uplink transmission at #1022 may occur during a first time slot, while a downlink transmission at #1020 and a sidelink transmission at #1024 may occur during a later time slot. Alternatively (e.g., where a full-duplex communication occurs at the TRPs), in scenarios where the user equipment 1006 supports a slower relaying capability (e.g., a decode and forward capability), an uplink transmission at #1020 and a downlink transmission at #1022 may occur during the same time slot, while a sidelink transmission at #1024 may occur during a later time slot. Similarly, in scenarios where the user equipment 1006 supports a slower relaying capability (e.g., a decode and forward capability), an uplink transmission at 1020 and a downlink transmission at #1022 may occur during the same time slot, while a sidelink transmission at #1024 may occur during a later time slot.

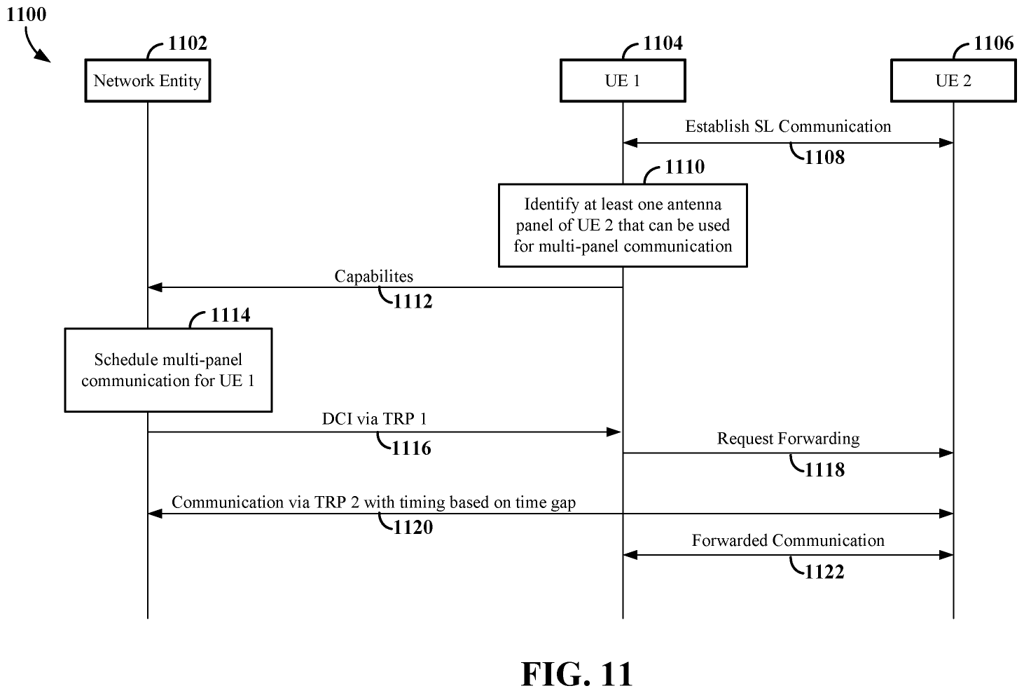

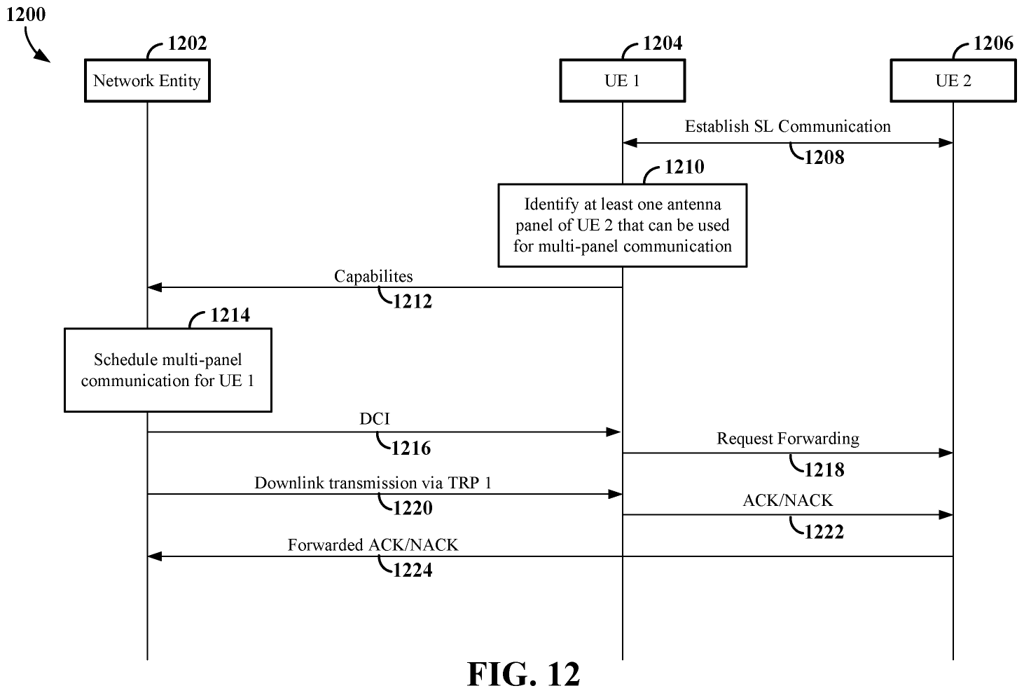

As discussed above, in some examples, a minimum time gap may be specified for multi-panel communication. FIGS. 11 and 12 illustrate two examples where such a time gap may be employed. Other time gap operations may be used in other examples.

FIG. 11 is a signaling diagram 1100 illustrating an example of using different panels for DCI and data in a wireless communication system including a network entity 1102 (e.g., a base station), a user equipment 1104 (UE 1), and a user equipment 1106 (UE 2). In some examples, the network entity 1102 may correspond to any of the network entities, base stations, CUs, DU, RUs, or scheduling entities shown in any of FIGS. 1-3, 5-8, 10, 12, and 15. In some examples, the user equipment 1104 and the user equipment 1106 may correspond to any of the UEs or scheduled entities shown in any of FIGS. 1-3, 5-8, 10, 12, and 13.

At #1108 of FIG. 11, the user equipment 1104 and the user equipment 1106 establish sidelink communication. For example, the user equipment 1104 and the user equipment 1106 may perform sidelink discovery and other related operations as described above. In some examples, the user equipment 1104 may determine relaying capabilities of the user equipment 1106 (e.g., how quickly the user equipment 1106 can relay data).

At #1110, the user equipment 1104 may identify one or more antenna panels of the user equipment 1106 that the user equipment 1104 may use for multi-panel communication. For example, the user equipment 1104 may determine an identifier of such an antenna panel and other configuration information (e.g., a beam index, a panel index, an ID of the user equipment 1106, etc.). In some examples, the user equipment 1104 may determine timing information associated with the different antenna panels (e.g., delays associated with different antenna panels).

At #1112, the user equipment 1104 advertises its capabilities. For example, the user equipment 1104 may transmit a capabilities message that indicates the antenna panels that are available for a multi-panel transmission to the user equipment 1104 and/or the antenna panels that are available for a multi-panel reception from the user equipment 1104. In some examples (e.g., as the antenna panel information changes), the user equipment 1104 may sent this information via uplink control information (UCI), a MAC-CE, or an RRC message.

In some examples, the user equipment 1104 determines whether a minimum time gap should be applied to a multi-panel transmission to the user equipment 1104 and/or a multi-panel reception from the user equipment 1104, and sends an indication of this time gap to the network entity 1102. For example, if the user equipment 1104 will receive a DCI on its own panel 1 and the DCI schedules DL or UL data on panel 2 of the user equipment 1106, a longer scheduling offset between the DCI and the scheduled data may be needed for the user equipment 1104 to inform the user equipment 1106 of the DL or UL grant.

At #1114, the network entity 1102 schedules a multi-panel communication for the user equipment 1104. For example, the network entity 1102 may configure a first TRP (TRP 1) to communicate with a first antenna panel of the user equipment 1104 and configure a second TRP (TRP 2) to communicate with a second antenna panel of the user equipment 1106.

In some examples, the network entity 1102 determines whether a minimum time gap should be applied to a multi-panel transmission to the user equipment 1104 and/or a multi-panel reception from the user equipment 1104 (e.g., based on capabilities of the user equipment 1104 and/or 1106 and/or characteristics associated with the antenna panels). For example, if the user equipment 1104 will receive a DCI on its own panel 1 and the DCI schedules DL or UL data on panel 2 of the user equipment 1106, a longer scheduling offset between the DCI and the scheduled data may be needed for the user equipment 1104 to inform the user equipment 1106 of the DL or UL grant.

At #1116, the network entity 1102 transmits a DCI for the multi-panel communication to the user equipment 1104 via TRP 1. As discussed herein, the DCI may include scheduling information (e.g., time slot resources, bandwidth resources, MCS, etc.) for the multi-panel communication, along with information (e.g., beam information) relating to the antenna panels and/or TRPs to be used for the communication. In addition, the DCI may indicate (e.g., by the scheduled timing) whether a time gap is being used for the multi-panel communication.

At #1118, the user equipment 1104 sends a message to the user equipment 1106 that requests the user equipment 1106 to perform a forwarding operation in conjunction with the multi-panel communication indicated by the DCI of #1116. For example, the user equipment 1104 may request that the user equipment 1106 forward to the user equipment 1104 any data received via the second antenna panel of the user equipment 1106 during a designated time slot. As another example, the user equipment 1104 may request that the user equipment 1106 forward via the second antenna panel any data received from the user equipment 1106 during a designated time slot.

At #1120, the network entity 1102 and the user equipment 1106 conduct a communication (e.g., a downlink transmission or an uplink transmission scheduled by the DCI) via the second TRP. Furthermore, at #1122, the user equipment 1106 forwards the information for the communication at #1120 to or from the user equipment 1104. As discussed herein, a minimum time gap may be employed to account for any delay associated with receiving or transmitting via TRP 2 data that was scheduled by the DCI sent via TRP 1 (e.g., the ACK/NACK timing may be delayed).

FIG. 12 is a signaling diagram 1200 illustrating an example of using different panels for data and ACK/NACK signaling in a wireless communication system including a network entity 1202 (e.g., a base station), a user equipment 1204 (UE 1), and a user equipment 1206 (UE 2). In some examples, the network entity 1202 may correspond to any of the network entities, base stations, CUs, DU, RUs, or scheduling entities shown in any of FIGS. 1-3, 5-8, 10, 11, and 15. In some examples, the user equipment 1204 and the user equipment 1206 may correspond to any of the UEs or scheduled entities shown in any of FIGS. 1-3, 5-8, 10, 11, and 13.

At #1208 of FIG. 12, the user equipment 1204 and the user equipment 1206 establish sidelink communication. For example, the user equipment 1204 and the user equipment 1206 may perform sidelink discovery and other related operations as described above. In some examples, the user equipment 1204 may determine relaying capabilities of the user equipment 1206 (e.g., how quickly the user equipment 1206 can relay data).

At #1210, the user equipment 1204 may identify one or more antenna panels of the user equipment 1206 that the user equipment 1204 may use for multi-panel communication. For example, the user equipment 1204 may determine an identifier of such an antenna panel and other configuration information (e.g., a beam index, a panel index, an ID of the user equipment 1206, etc.). In some examples, the user equipment 1204 may determine timing information associated with the different antenna panels (e.g., delays associated with different antenna panels).

At #1212, the user equipment 1204 advertises its capabilities. For example, the user equipment 1204 may transmit a capabilities message that indicates the antenna panels that are available for a multi-panel transmission to the user equipment 1204 and/or the antenna panels that are available for a multi-panel reception from the user equipment 1204. In some examples (e.g., as the antenna panel information changes), the user equipment 1204 may sent this information via uplink control information (UCI), a MAC-CE, or an RRC message.

In some examples, the user equipment 1204 determines whether a minimum time gap should be applied to a multi-panel transmission to the user equipment 1204 and/or a multi-panel reception from the user equipment 1204, and sends an indication of this time gap to the network entity 1202. For example, if DL data is to be received on panel 2 of the user equipment 1206 but the corresponding UL ACK/NACK (A/N) is to be transmitted on panel 1 of the user equipment 1204, a longer offset between the DL data and the UL A/N may be needed for the user equipment 1206 to inform the user equipment 1204 of the decoding results.

At #1214, the network entity 1202 schedules a multi-panel communication for the user equipment 1204. For example, the network entity 1202 may configure a first TRP (TRP 1) to communicate with a first antenna panel of the user equipment 1204 and configure a second TRP (TRP 2) to communicate with a second antenna panel of the user equipment 1206.

In some examples, the network entity 1202 determines whether a minimum time gap should be applied to a multi-panel transmission to the user equipment 1204 and/or a multi-panel reception from the user equipment 1204 (e.g., based on capabilities of the user equipment 1204 and/or 1206 and/or characteristics associated with the antenna panels). For example, if DL data is to be received on panel 2 of the user equipment 1206 but the corresponding UL ACK/NACK (A/N) is to be transmitted on panel 1 of the user equipment 1204, a longer offset between the DL data and the UL A/N may be needed for the user equipment 1206 to inform the user equipment 1204 of the decoding results.

At #1216, the network entity 1202 transmits a DCI for the multi-panel communication to the user equipment 1204. As discussed herein, the DCI may include scheduling information (e.g., time slot resources, bandwidth resources, MCS, etc.) for the multi-panel communication, along with information (e.g., beam information) relating to the antenna panels and/or TRPs to be used for the communication. In addition, the DCI may indicate (e.g., by the scheduled timing) whether a time gap is being used for the multi-panel communication.

At #1218, the user equipment 1204 sends a message to the user equipment 1206 that requests the user equipment 1206 to perform a forwarding operation in conjunction with the multi-panel communication indicated by the DCI of #1216. For example, the user equipment 1204 may request that the user equipment 1206 forward via the second antenna panel any data received from the user equipment 1206 during a designated time slot.

At #1220, the network entity 1202 transmits a downlink transmission to the user equipment 1204 via the first TRP. At #1222, the user equipment 1204 transmit and ACK/NACK for the downlink transmission to the user equipment 1206. At #1224, the user equipment 1206 forwards the ACK/NACK to TRP 2. As discussed herein, a minimum time gap may be employed to account for any delay associated with receiving data via TRP 1 and sending the corresponding ACK/NACK via TRP 2 (e.g., the downlink transmission via TRP 2 may be delayed).

Operations similar to those discussed above in conjunction with FIG. 12 may be performed for a scenario where a downlink transmission is received on panel 2 and the ACK/NACK is transmitted via panel 1.

FIG. 13 is a block diagram illustrating an example of a hardware implementation for an apparatus 1300 employing a processing system 1314. For example, the apparatus 1300 may be a device configured to wirelessly communicate with a network entity, as discussed in any one or more of FIGS. 1-12. In some implementations, the apparatus 1300 may correspond to any of the UEs or scheduled entities shown in any of FIGS. 1-3, 5-8, and 10-12.

In accordance with various aspects of the disclosure, an element, or any portion of an element, or any combination of elements may be implemented with the processing system 1314. The processing system 1314 may include one or more processors 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1300 may be configured to perform any one or more of the functions described herein. That is, the processor 1304, as utilized in an apparatus 1300, may be used to implement any one or more of the processes and procedures described herein.

The processor 1304 may in some instances be implemented via a baseband or modem chip and in other implementations, the processor 1304 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 communicatively couples together various circuits including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, will not be described any further. A bus interface 1308 provides an interface between the bus 1302, a transceiver 1310 and an antenna array 1320 and between the bus 1302 and an interface 1330. The transceiver 1310 provides a communication interface or means for communicating with various other apparatus over a wireless transmission medium. The interface 1330 provides a communication interface or means of communicating with various other apparatuses and devices (e.g., other devices housed within the same apparatus as the scheduled entity or other external apparatuses) over an internal bus or external transmission medium, such as an Ethernet cable. Depending upon the nature of the apparatus 1300, the interface 1330 may include a user interface (e.g., keypad, display, speaker, microphone, joystick). Of course, such a user interface is optional, and may be omitted in some examples, such as an IoT device.

The processor 1304 is responsible for managing the bus 1302 and general processing, including the execution of software stored on the computer-readable medium 1306. The software, when executed by the processor 1304, causes the processing system 1314 to perform the various functions described below for any particular apparatus. The computer-readable medium 1306 and the memory 1305 may also be used for storing data that is manipulated by the processor 1304 when executing software. For example, the memory 1305 may store antenna panel information 1315 (e.g., antenna configuration information) used by the processor 1304 for the antenna port-related operations described herein.

One or more processors 1304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1306.

The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

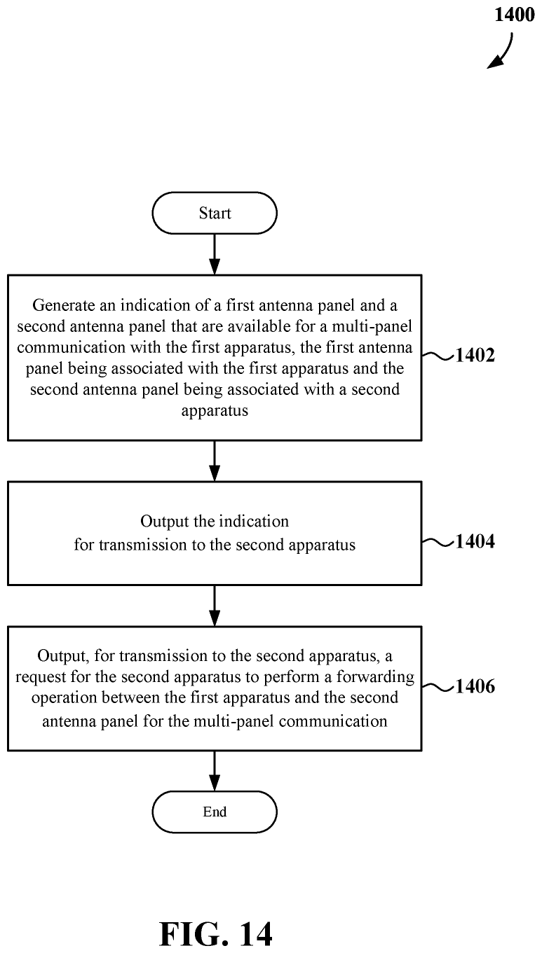

The apparatus 1300 may be configured to perform any one or more of the operations described herein (e.g., as described above in conjunction with FIGS. 1-12 and as described below in conjunction with FIG. 14). In some aspects of the disclosure, the processor 1304, as utilized in the apparatus 1300, may include circuitry configured for various functions.

The processor 1304 may include communication and processing circuitry 1341. The communication and processing circuitry 1341 may be configured to communicate with a scheduling entity, such as a gNB. The communication and processing circuitry 1341 may be configured to communicate with a base station and one or more other wireless communication devices over a common carrier shared between a cellular (e.g., Uu) interface and a sidelink (e.g., PC5) interface. The communication and processing circuitry 1341 may include one or more hardware components that provide the physical structure that performs various processes related to wireless communication (e.g., signal reception and/or signal transmission) as described herein. The communication and processing circuitry 1341 may further include one or more hardware components that provide the physical structure that performs various processes related to signal processing (e.g., processing a received signal and/or processing a signal for transmission) as described herein. In some examples, the communication and processing circuitry 1341 may include two or more transmit/receive chains (e.g., one chain to communicate with a base station and another chain to communicate with a sidelink device). The communication and processing circuitry 1341 may further be configured to execute communication and processing software 1351 included on the computer-readable medium 1306 to implement one or more functions described herein.

In some implementations where the communication involves obtaining (e.g., receiving) information, the communication and processing circuitry 1341 may obtain information from a component of the apparatus 1300 (e.g., from the transceiver 1310 that receives the information via radio frequency signaling or some other type of signaling suitable for the applicable communication medium), process (e.g., decode) the information, and output the processed information. For example, the communication and processing circuitry 1341 may output the information to another component of the processor 1304, to the memory 1305, or to the bus interface 1308. In some examples, the communication and processing circuitry 1341 may receive one or more of signals, messages, other information, or any combination thereof. In some examples, the communication and processing circuitry 1341 may receive information via one or more channels. In some examples, the communication and processing circuitry 1341 may receive one or more of signals, messages, SCIs, feedback, other information, or any combination thereof. In some examples, the communication and processing circuitry 1341 may receive information via one or more of a PSCCH, a PSSCH, a PSFCH, some other type of channel, or any combination thereof.

In some examples, the communication and processing circuitry 1341 may include functionality for a means for obtaining (e.g., obtaining indications, signals, etc., from another apparatus). In some examples, the communication and processing circuitry 1341 may include functionality for a means for receiving (e.g., receiving indications, data, or other information from another apparatus). In some examples, the communication and processing circuitry 1341 may include functionality for a means for decoding. In some examples, the communication and processing circuitry 1341 may include functionality for a means for obtaining data received via a first antenna panel (e.g., first data from a first TRP as described above in conjunction with FIGS. 8-12). In some examples, the communication and processing circuitry 1341 may include functionality for a means for obtaining data received from a second apparatus (e.g., second data received from a UE via a sidelink channel as described above in conjunction with FIGS. 8-12).

In some implementations where the communication involves outputting (e.g., transmitting) information, the communication and processing circuitry 1341 may obtain information (e.g., from another component of the processor 1304, the memory 1305, or the bus interface 1308), process (e.g., encode) the information, and output the processed information. For example, the communication and processing circuitry 1341 may output the information to the transceiver 1310 (e.g., that transmits the information via radio frequency signaling or some other type of signaling suitable for the applicable communication medium). In some examples, the communication and processing circuitry 1341 may send one or more of signals, messages, other information, or any combination thereof. In some examples, the communication and processing circuitry 1341 may send information via one or more channels. In some examples, the communication and processing circuitry 1341 may send one or more of signals, messages, SCIs, feedback, other information, or any combination thereof. In some examples, the communication and processing circuitry 1341 may send information via one or more of a PSCCH, a PSSCH, a PSFCH, some other type of channel, or any combination thereof.

In some examples, the communication and processing circuitry 1341 may include functionality for a means for outputting (e.g., outputting indications or other information to another apparatus). In some examples, the communication and processing circuitry 1341 may include functionality for a means for sending (e.g., sending indications or other information to another entity). In some examples, the communication and processing circuitry 1341 may include functionality for a means for transmitting (e.g., transmitting an indication, a request, data, or other information to another apparatus). In some examples, the communication and processing circuitry 1341 may include functionality for a means for encoding. In some examples, the communication and processing circuitry 1341 may include functionality for a means for outputting data to be transmitted via a first antenna panel (e.g., first data to be transmitted to a first TRP as described above in conjunction with FIGS. 8-12). In some examples, the communication and processing circuitry 1341 may include functionality for a means for outputting data to be transmitted to a second apparatus (e.g., second data to be transmitted to a UE via a sidelink channel as described above in conjunction with FIGS. 8-12).

The processor 1304 may include antenna panel configuration circuitry 1342 configured to perform antenna panel configuration-related operations as discussed herein (e.g., one or more of the operations described above in conjunction with FIGS. 8-12). The antenna panel configuration circuitry 1342 may be configured to execute antenna panel configuration software 1352 included on the computer-readable medium 1306 to implement one or more functions described herein.

The antenna panel configuration circuitry 1342 may include functionality for a means for generating an indication of a first antenna panel and a second antenna panel that are available for a multi-panel communication (e.g., as described above in conjunction with FIGS. 8-12). For example, the antenna panel configuration circuitry 1342 may acquire antenna information of a neighboring UE (e.g., via a sidelink) and generate the indication based on this acquired information and information about an antenna panel associated with the apparatus 1300.

The antenna panel configuration circuitry 1342 may include functionality for a means for outputting an indication of a first antenna panel and a second antenna panel that are available for a multi-panel communication (e.g., as described above in conjunction with FIGS. 8-12). For example, the antenna panel configuration circuitry 1342 together with the communication and processing circuitry 1341 and the transceiver 1310 may transmit the indication via a capabilities message, UCI, a MAC-CE, or RRC signaling. In some examples, the antenna panel configuration circuitry 1542 may report the availability of multiple panels for a multi-panel communication in a scenario where a single panel communication does not provide sufficient throughput, bandwidth, etc. In some examples, the antenna panel configuration circuitry 1542 may measure link quality to a sidelink UE and, if the link quality is acceptable, elect to use one or more antenna panels of the sidelink UE for the multi-panel communication. In some examples, the antenna panel configuration circuitry 1542 may request the sidelink UE to send information about its antenna panels to the apparatus 1300 and include this information in the indication.

The processor 1304 may include forwarding configuration circuitry 1343 configured to perform forwarding configuration-related operations as discussed herein (e.g., one or more of the operations described above in conjunction with FIGS. 8-12). The forwarding configuration circuitry 1343 may be configured to execute forwarding configuration software 1353 included on the computer-readable medium 1306 to implement one or more functions described herein.

The forwarding configuration circuitry 1343 may include functionality for a means for outputting a request (e.g., as described above in conjunction with FIGS. 8-12). For example, the forwarding configuration circuitry 1343 together with the communication and processing circuitry 1341 and the transceiver 1310 may send a sidelink message to a UE requesting the UE to perform a forwarding operation.

FIG. 14 is a flow chart illustrating an example method 1400 for an apparatus in accordance with some aspects of the present disclosure. As described below, some or all illustrated features may be omitted in a particular implementation within the scope of the present disclosure, and some illustrated features may not be required for implementation of all examples. In some examples, the method 1400 may be carried out by the apparatus 1300 illustrated in FIG. 13. In some examples, the method 1400 may be carried out by any suitable apparatus or means for carrying out the functions or algorithm described below.

At block 1402, an apparatus may generate an indication of a first antenna panel and a second antenna panel that are available for a multi-panel communication with the first apparatus, the first antenna panel being associated with the first apparatus and the second antenna panel being associated with a second apparatus. In some examples, the antenna panel configuration circuitry 1342, shown and described in FIG. 13, may provide a means to generate an indication of a first antenna panel and a second antenna panel that are available for a multi-panel communication with the first apparatus. In some examples, the antenna panel configuration circuitry 1342 in cooperation with the communication and processing circuitry 1341 and the transceiver 1310, shown and described in FIG. 13, may provide a means to generate an indication of a first antenna panel and a second antenna panel that are available for a multi-panel communication with the first apparatus.

At block 1404, the apparatus may output the indication for transmission to a network entity. In some examples, the antenna panel configuration circuitry 1342, shown and described in FIG. 13, may provide a means to output the indication for transmission to a network entity. In some examples, the antenna panel configuration circuitry 1342 in cooperation with the communication and processing circuitry 1341 and the transceiver 1310, shown and described in FIG. 13, may provide a means to output the indication for transmission to a network entity.

At block 1406, the apparatus may output, for transmission to the second apparatus, a request for the second apparatus to perform a forwarding operation between the first apparatus and the second antenna panel for the multi-panel communication. In some examples, the forwarding configuration circuitry 1343 may provide a means to output, for transmission to the second apparatus, a request for the second apparatus to perform a forwarding operation between the first apparatus and the second antenna panel for the multi-panel communication. In some examples, the forwarding configuration circuitry 1343 in cooperation with the communication and processing circuitry 1341 and the transceiver 1310, shown and described in FIG. 13, may provide a means to output, for transmission to the second apparatus, a request for the second apparatus to perform a forwarding operation between the first apparatus and the second antenna panel for the multi-panel communication. In some examples, the request may be a sidelink message.

In some examples, the first apparatus may obtain first data of the multi-panel communication that is received via the first antenna panel. In some examples, the first apparatus may obtain second data of the multi-panel communication that is received from the second apparatus. In some examples, the first data is obtained from a transmit receive point, and the second data is obtained via a sidelink established between the first apparatus and the second apparatus.

In some examples, the first apparatus may output, for transmission via the first antenna panel, first data of the multi-panel communication. In some examples, the first apparatus may output, for transmission to the second apparatus, second data of the multi-panel communication. In some examples, the first data is output for transmission to a transmit receive point, and the second data is output for transmission via a sidelink established between the first apparatus and the second apparatus.

In some examples, the first apparatus may obtain first data of the multi-panel communication that is received via the first antenna panel, and output, for transmission to the second apparatus, second data of the multi-panel communication, or output, for transmission via the first antenna panel, third data of the multi-panel communication, and obtain fourth data of the multi-panel communication that was received from the second apparatus.

In some examples, the indication may include a first configuration associated with the first antenna panel and a second configuration associated with the second antenna panel. In some examples, the indication specifies a quantity of antenna panels associated with the second apparatus. In some examples, the indication may include a first identifier associated with the first antenna panel and a second identifier associated with the second antenna panel. In some examples, the indication identifies at least one third antenna panel that will not be used for the multi-panel communication.

In some examples, the indication specifies whether the first antenna panel is available for downlink transmission only, uplink transmissions only, or both uplink transmissions and downlink transmissions. In some examples, the indication specifies whether the second antenna panel is available for downlink transmission only, uplink transmissions only, or both uplink transmissions and downlink transmissions.

In some examples, the indication specifies at least one of, for the first antenna panel, a first maximum quantity of downlink multiple-input multiple-output (MIMO) layers, a first maximum quantity of downlink demodulation reference signal (DMRS) ports, a first maximum quantity of channel state information-reference signal (CSI-RS) ports per CSI-RS resource for channel state feedback (CSF), or a first maximum quantity of downlink analog beams, and for the second antenna panel, a second maximum quantity of downlink MIMO layers, a second maximum quantity of downlink DMRS ports, a second maximum quantity of CSI-RS ports per CSI-RS resource for CSF, or a second maximum quantity of downlink analog beams.

In some examples, the indication specifies at least one of, for the first antenna panel, a first maximum quantity of uplink antenna ports, a first maximum quantity of uplink multiple-input multiple-output (MIMO) layers, or a first maximum quantity of uplink analog beams, and for the second antenna panel, a second maximum quantity of uplink antenna ports, a second maximum quantity of uplink MIMO layers, or a second maximum quantity of uplink analog beams.

In some examples, the indication specifies at least one set of one or more antenna panels that are not to be used for the multi-panel communication. In some examples, the indication identifies antenna panels that share at least one of a digital port, a transmit chain, or a receive chain.

In some examples, the indication specifies at least one minimum time gap between transmissions associated with the multi-panel communication. In some examples, the indication specifies that a longer offset (i.e., longer than another defined offset) is needed between a DCI and data scheduled by the DCI. In some examples, the indication specifies that a longer offset (i.e., longer than another defined offset) is needed between downlink data and an uplink acknowledgement.

In some examples, the at least one minimum time gap may include at least one of a first minimum time gap between a first downlink transmission associated with the first antenna panel and a second downlink transmission associated with the second antenna panel, or a second minimum time gap between a first uplink transmission associated with the first antenna panel and a second uplink transmission associated with the second antenna panel.

In some examples, the at least one minimum time gap may include at least one of a first minimum time gap between a first downlink transmission associated with the first antenna panel and a first uplink transmission associated with the second antenna panel, or a second minimum time gap between a second uplink transmission associated with the first antenna panel and a second downlink transmission associated with the second antenna panel.

In some examples, the at least one minimum time gap may include at least one of a first minimum time gap between a first downlink control information transmission associated with the first antenna panel and a first data transmission associated with the second antenna panel, wherein the first downlink control information schedules the first data transmission, or a second minimum time gap between a second downlink control information transmission associated with the second antenna panel and a second data transmission associated with the first antenna panel, wherein the second downlink control information schedules the second data transmission.

In some examples, the at least one minimum time gap may include at least one of a first minimum time gap between a first downlink transmission associated with the first antenna panel and a first acknowledgment transmission associated with the second antenna panel, wherein the first acknowledgment transmission is associated with the first downlink transmission, or a second minimum time gap between a second downlink transmission associated with the second antenna panel and a second acknowledgment transmission associated with the first antenna panel, wherein the second acknowledgment transmission is associated with the second downlink transmission.

In some examples, the at least one minimum time gap may include a first time gap associated with the first antenna panel, and a second time gap associated with the second antenna panel, wherein the second time gap is different from the first time gap.

In some examples, the indication is output for transmission to the network entity via at least one of uplink control information, a medium access control-control element (MAC-CE), or a radio resource control (RRC) message.

In some examples, the first apparatus may include a transmitter configured to transmit the indication and the request, wherein the first apparatus is configured as a user equipment.

In one configuration, the apparatus 1300 includes means for generating an indication of a first antenna panel and a second antenna panel that are available for a multi-panel communication with the first apparatus, the first antenna panel being associated with the first apparatus and the second antenna panel being associated with a second apparatus, means for outputting the indication for transmission to a network entity, and means for outputting, for transmission to the second apparatus, a request for the second apparatus to perform a forwarding operation between the first apparatus and the second antenna panel for the multi-panel communication. In one aspect, the aforementioned means may be the processor 1304 shown in FIG. 13 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1304 is merely provided as an example, and other means for carrying out the described functions may be included within various aspects of the present disclosure, including but not limited to the instructions stored in the computer-readable medium 1306, or any other suitable apparatus or means described in any one or more of FIGS. 1-3, 5-8, and 10-13, and utilizing, for example, the methods and/or algorithms described herein in relation to FIG. 14.

FIG. 15 is a conceptual diagram illustrating an example of a hardware implementation for an apparatus 1500 employing a processing system 1514. In some implementations, the apparatus 1500 may correspond to any of the network entities, base stations (e.g., gNBs), CUs, DUs, RUs, or scheduling entities shown in any of FIGS. 1-3, 5-8, and 10-12.

In accordance with various aspects of the disclosure, an element, or any portion of an element, or any combination of elements may be implemented with the processing system 1514. The processing system may include one or more processors 1504. The processing system 1514 may be substantially the same as the processing system 1314 illustrated in FIG. 13, including a bus interface 1508, a bus 1502, memory 1505, a processor 1504, a computer-readable medium 1506, a transceiver 1510, and an antenna array 1520. The memory 1505 may store antenna panel information 1515 (e.g., antenna configuration information) used by the processor 1504 in cooperation with the transceiver 1510 for the antenna port-related operations described herein. Furthermore, the apparatus 1500 may include an interface 1530 (e.g., a network interface) that provides a means for communicating with at least one other apparatus within a core network and with at least one radio access network.

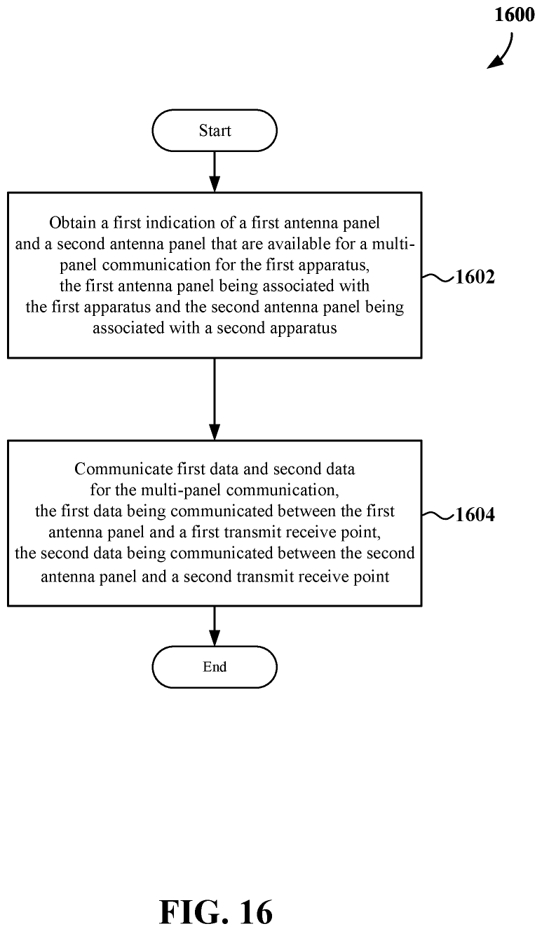

The apparatus 1500 may be configured to perform any one or more of the operations described herein (e.g., as described above in conjunction with FIGS. 1-12 and as described below in conjunction with FIG. 16). In some aspects of the disclosure, the processor 1504, as utilized in the apparatus 1500, may include circuitry configured for various functions.

The processor 1504 may be configured to generate, schedule, and modify a resource assignment or grant of time-frequency resources (e.g., a set of one or more resource elements). For example, the processor 1504 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 1504 may be configured to schedule resources for the transmission of downlink signals. The processor 1504 may further be configured to schedule resources for the transmission of uplink signals.

In some aspects of the disclosure, the processor 1504 may include communication and processing circuitry 1541. The communication and processing circuitry 1541 may be configured to communicate with a scheduled entity. The communication and processing circuitry 1541 may include one or more hardware components that provide the physical structure that performs various processes related to communication (e.g., signal reception and/or signal transmission) as described herein. The communication and processing circuitry 1541 may further include one or more hardware components that provide the physical structure that performs various processes related to signal processing (e.g., processing a received signal and/or processing a signal for transmission) as described herein. The communication and processing circuitry 1541 may further be configured to execute communication and processing software 1551 included on the computer-readable medium 1506 to implement one or more functions described herein.

The communication and processing circuitry 1541 may further be configured to receive a message from a UE. For example, the message may be included in a MAC-CE carried in a Uu PUSCH or a PSCCH, or included in a Uu RRC message or an SL RRC message, or included in a dedicated Uu PUCCH or PUSCH. The communication and processing circuitry 1541 may further be configured to receive a scheduling request from a UE for an uplink grant or a sidelink grant.

In some implementations wherein the communication involves obtaining (e.g., receiving) information, the communication and processing circuitry 1541 may obtain information from a component of the apparatus 1500 (e.g., from the transceiver 1510 that receives the information via radio frequency signaling or some other type of signaling suitable for the applicable communication medium), process (e.g., decode) the information, and output the processed information. For example, the communication and processing circuitry 1541 may output the information to another component of the processor 1504, to the memory 1505, or to the bus interface 1508. In some examples, the communication and processing circuitry 1541 may receive one or more of signals, messages, other information, or any combination thereof. In some examples, the communication and processing circuitry 1541 may receive information via one or more channels. In some examples, the communication and processing circuitry 1541 may include functionality for a means for obtaining (e.g., obtaining indications, signals, or other information from another apparatus). In some examples, the communication and processing circuitry 1541 may include functionality for a means for receiving (e.g., receiving indications, data, or other information from another apparatus). In some examples, the communication and processing circuitry 1541 may include functionality for a means for decoding.

In some implementations wherein the communication involves outputting (e.g., transmitting) information, the communication and processing circuitry 1541 may obtain information (e.g., from another component of the processor 1504, the memory 1505, or the bus interface 1508), process (e.g., encode) the information, and output the processed information. For example, the communication and processing circuitry 1541 may output the information to the transceiver 1510 (e.g., that transmits the information via radio frequency signaling or some other type of signaling suitable for the applicable communication medium). In some examples, the communication and processing circuitry 1541 may send one or more of signals, messages, other information, or any combination thereof. In some examples, the communication and processing circuitry 1541 may send information via one or more channels. In some examples, the communication and processing circuitry 1541 may include functionality for a means for sending (e.g., a means for transmitting). In some examples, the communication and processing circuitry 1541 may include functionality for a means for encoding. In some examples, the communication and processing circuitry 1541 may include functionality for a means for outputting (e.g., outputting indications, signals, or other information to another apparatus). In some examples, the communication and processing circuitry 1541 may include functionality for a means for transmitting (e.g., transmitting data or other information to another apparatus).

The processor 1504 may include antenna panel configuration circuitry 1542 configured to perform antenna panel configuration-related operations as discussed herein (e.g., one or more of the operations described above in conjunction with FIGS. 8-12). The antenna panel configuration circuitry 1542 may be configured to execute antenna panel configuration software 1552 included on the computer-readable medium 1506 to implement one or more functions described herein.

The antenna panel configuration circuitry 1542 may include functionality for a means for obtaining an indication of a first antenna panel and a second antenna panel that are available for a multi-panel communication (e.g., as described above in conjunction with FIGS. 8-12). For example, the antenna panel configuration circuitry 1542 may receive the indication via UE capabilities information, UCI, a MAC-CE, or RRC signaling.

The antenna panel configuration circuitry 1542 may include functionality for a means for configuring a TRP (e.g., as described above in conjunction with FIGS. 8-12). For example, the antenna panel configuration circuitry 1542 may configure a first TRP to transmit to or receive from a first antenna panel for the multi-panel communication, and configure a second TRP to transmit to or receive from a second antenna panel.

The processor 1504 may include multi-panel scheduling circuitry 1543 configured to perform multi-panel scheduling-related operations as discussed herein (e.g., one or more of the operations described above in conjunction with FIGS. 8-12). The multi-panel scheduling circuitry 1543 may be configured to execute multi-panel scheduling software 1553 included on the computer-readable medium 1506 to implement one or more functions described herein.

The multi-panel scheduling circuitry 1543 may include functionality for a means for communicating data via multiple antenna panels (e.g., as described above in conjunction with FIGS. 8-12). For example, the multi-panel scheduling circuitry 1543 may transmit first data via a first TRP to a first antenna panel of a first UE and transmit second data via a second TRP to a second antenna panel of a second UE, where the second UE forwards the second data to the first UE. As another example, the multi-panel scheduling circuitry 1543 may transmit receive first data via a first TRP from a first antenna panel of a first UE and receive second data via a second TRP from a second antenna panel of a second UE, where the second UE forwards the second data from the first UE.

The multi-panel scheduling circuitry 1543 may include functionality for a means for scheduling (e.g., as described above in conjunction with FIGS. 8-12). For example, the antenna panel configuration circuitry 1542 may schedule a multi-panel communication for a UE in a scenario where a single panel communication does not provide sufficient throughput, bandwidth, etc. As another example, the antenna panel configuration circuitry 1542 may schedule a multi-panel communication for a UE in a scenario where the UE has reported that multiple antenna panels are available for simultaneous communication. In some examples, the antenna panel configuration circuitry 1542 may schedule a simultaneous transmission to a first UE via a first TRP that transmits to a first panel on the first UE and via a second TRP that transmits to a second panel on a second UE. In some examples, the antenna panel configuration circuitry 1542 may schedule a simultaneous reception from a first UE via a first TRP that received data from a first panel on the first UE and via a second TRP that received data from a second panel on a second UE. In some examples, the antenna panel configuration circuitry 1542 may schedule a full-duplex communication with a first UE via a first TRP that communicates with a first panel on the first UE and via a second TRP that communicated with a second panel on a second UE.

The multi-panel scheduling circuitry 1543 may include functionality for a means for scheduling based on a time gap (e.g., as described above in conjunction with FIGS. 8-12). For example, the antenna panel configuration circuitry 1542 may schedule a multi-panel transmission or reception for a UE based on at least one minimum time gap.

FIG. 16 is a flow chart illustrating an example method 1600 for a wireless communication system in accordance with some aspects of the present disclosure. As described below, some or all illustrated features may be omitted in a particular implementation within the scope of the present disclosure, and some illustrated features may not be required for implementation of all examples. In some examples, the method 1600 may be carried out by the apparatus 1500 illustrated in FIG. 15. In some examples, the method 1600 may be carried out by any suitable apparatus or means for carrying out the functions or algorithm described below.

At block 1602, a first apparatus may obtain an indication of a first antenna panel and a second antenna panel that are available for a multi-panel communication with a first user equipment, the first antenna panel being associated with the first user equipment and the second antenna panel being associated with a second user equipment. In some examples, the antenna panel configuration circuitry 1542, shown and described in FIG. 15, may provide a means to obtain an indication of a first antenna panel and a second antenna panel that are available for a multi-panel communication for a first user equipment. In some examples, the antenna panel configuration circuitry 1542 in cooperation with the communication and processing circuitry 1541 and the transceiver 1510, shown and described in FIG. 15, may provide a means to obtain an indication of a first antenna panel and a second antenna panel that are available for a multi-panel communication with a first user equipment.

At block 1604, the first apparatus may communicate first data and second data for the multi-panel communication, the first data being communicated between the first antenna panel and a first transmit receive point, the second data being communicated between the second antenna panel and a second transmit receive point. In some examples, the multi-panel scheduling circuitry 1543, shown and described in FIG. 15, may provide a means to communicate first data and second data for the multi-panel communication. In some examples, the multi-panel scheduling circuitry 1543 together with the communication and processing circuitry 1541 and the transceiver 1510, shown and described in FIG. 15, may provide a means to communicate first data and second data for the multi-panel communication.

In some examples, the first apparatus may schedule a simultaneous transmission or reception for the first user equipment based on the first antenna panel and a second antenna panel being available for the multi-panel communication.

In some examples, the first apparatus may configure the first transmit receive point to transmit to or receive from the first antenna panel for the multi-panel communication, and configure the second transmit receive point to transmit to or receive from the second antenna panel for the multi-panel communication.

In some examples, the indication specifies at least one of a first configuration associated with the first antenna panel and a second configuration associated with the second antenna panel, a quantity of antenna panels associated with the second user equipment, a first identifier associated with the first antenna panel and a second identifier associated with the second antenna panel, or at least one third antenna panel that will not be used for the multi-panel communication.

In some examples, the indication specifies at least one minimum time gap between transmissions for the multi-panel communication, and the processing system is further configured to schedule a multi-panel transmission or reception for the first user equipment based on the at least one minimum time gap.

In some examples, the at least one minimum time gap may include at least one of a first minimum time gap between a first downlink transmission associated with the first antenna panel and a second downlink transmission associated with the second antenna panel, or a second minimum time gap between a first uplink transmission associated with the first antenna panel and a second uplink transmission associated with the second antenna panel.

In some examples, the at least one minimum time gap may include at least one of a first minimum time gap between a first downlink transmission associated with the first antenna panel and a first uplink transmission associated with the second antenna panel, or a second minimum time gap between a second uplink transmission associated with the first antenna panel and a second downlink transmission associated with the second antenna panel.

In some examples, the at least one minimum time gap may include at least one of a first minimum time gap between a first downlink control information transmission associated with the first antenna panel and a first data transmission associated with the second antenna panel, wherein the first downlink control information schedules the first data transmission, or a second minimum time gap between a second downlink control information transmission associated with the second antenna panel and a second data transmission associated with the first antenna panel, wherein the second downlink control information schedules the second data transmission.

In some examples, the at least one minimum time gap may include at least one of a first minimum time gap between a first downlink transmission associated with the first antenna panel and a first acknowledgment transmission associated with the second antenna panel, wherein the first acknowledgment transmission is associated with the first downlink transmission, or a second minimum time gap between a second downlink transmission associated with the second antenna panel and a second acknowledgment transmission associated with the first antenna panel, wherein the second acknowledgment transmission is associated with the second downlink transmission.

In some examples, the at least one minimum time gap may include a first time gap associated with the first antenna panel, and a second time gap associated with the second antenna panel, wherein the second time gap is different from the first time gap.

In some examples, the first apparatus may include a transceiver configured to receive the indication and to transmit or receive the first data and the second data, wherein the first apparatus is configured as a network entity.

In one configuration, the apparatus 1500 includes means for obtaining an indication of a first antenna panel and a second antenna panel that are available for a multi-panel communication with a first user equipment, the first antenna panel being associated with the first user equipment and the second antenna panel being associated with a second user equipment, and means for communicating first data and second data for the multi-panel communication, the first data being communicated between the first antenna panel and a first transmit receive point, the second data being communicated between the second antenna panel and a second transmit receive point. In one aspect, the aforementioned means may be the processor 1504 shown in FIG. 15 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable medium 1506, or any other suitable apparatus or means described in any one or more of FIGS. 1-3, 5-8, 10-12, and 15, and utilizing, for example, the methods and/or algorithms described herein in relation to FIG. 16.

The methods shown in FIGS. 14 and 16 may include additional aspects, such as any single aspect or any combination of aspects described below and/or in connection with one or more other processes described elsewhere herein. The following provides an overview of several aspects of the present disclosure.

Aspect 1: A method for communication at a first apparatus, the method comprising: generating an indication of a first antenna panel and a second antenna panel that are available for a multi-panel communication with the first apparatus, the first antenna panel being associated with the first apparatus and the second antenna panel being associated with a second apparatus; outputting the indication for transmission to a network entity; and outputting, for transmission to the second apparatus, a request for the second apparatus to perform a forwarding operation between the first apparatus and the second antenna panel.

Aspect 2: The method of aspect 1, wherein the request comprises a sidelink message.

Aspect 3: The method of any of aspects 1 through 2, further comprising: obtaining first data of the multi-panel communication that is received via the first antenna panel; and obtaining second data of the multi-panel communication that is received from the second apparatus.

Aspect 4: The method of aspect 3, wherein: the first data is obtained from a transmit receive point; and the second data is obtained via a sidelink established between the first apparatus and the second apparatus.

Aspect 5: The method of any of aspects 1 through 2, further comprising: outputting, for transmission via the first antenna panel, first data of the multi-panel communication; and outputting, for transmission to the second apparatus, second data of the multi-panel communication.

Aspect 6: The method of aspect 5, wherein: the first data is output for transmission to a transmit receive point; and the second data is output for transmission via a sidelink established between the first apparatus and the second apparatus.

Aspect 7: The method of any of aspects 1 through 2, further comprising: obtaining first data of the multi-panel communication that was received via the first antenna panel, and outputting, for transmission to the second apparatus, second data of the multi-panel communication; or outputting, interface for transmission via the first antenna panel, third data of the multi-panel communication, and obtaining fourth data of the multi-panel communication that was received from the second apparatus.

Aspect 8: The method of any of aspects 1 through 7, wherein the indication comprises a first configuration associated with the first antenna panel and a second configuration associated with the second antenna panel.

Aspect 9: The method of any of aspects 1 through 8, wherein the indication specifies a quantity of antenna panels associated with the second apparatus.

Aspect 10: The method of any of aspects 1 through 9, wherein the indication comprises a first identifier associated with the first antenna panel and a second identifier associated with the second antenna panel.

Aspect 11: The method of any of aspects 1 through 10, wherein the indication identifies at least one third antenna panel that will not be used for the multi-panel communication.

Aspect 12: The method of any of aspects 1 through 11, wherein the indication specifies whether: the first antenna panel is available for downlink transmission only, uplink transmissions only, or both uplink transmissions and downlink transmissions; and the second antenna panel is available for downlink transmission only, uplink transmissions only, or both uplink transmissions and downlink transmissions.

Aspect 13: The method of any of aspects 1 through 12, wherein the indication specifies at least one of: for the first antenna panel, a first maximum quantity of downlink multiple-input multiple-output (MIMO) layers, a first maximum quantity of downlink demodulation reference signal (DMRS) ports, a first maximum quantity of channel state information-reference signal (CSI-RS) ports per CSI-RS resource for channel state feedback (CSF), or a first maximum quantity of downlink analog beams; and for the second antenna panel, a second maximum quantity of downlink MIMO layers, a second maximum quantity of downlink DMRS ports, a second maximum quantity of CSI-RS ports per CSI-RS resource for CSF, or a second maximum quantity of downlink analog beams.

Aspect 14: The method of any of aspects 1 through 12, wherein the indication specifies at least one of: for the first antenna panel, a first maximum quantity of uplink antenna ports, a first maximum quantity of uplink multiple-input multiple-output (MIMO) layers, or a first maximum quantity of uplink analog beams; and for the second antenna panel, a second maximum quantity of uplink antenna ports, a second maximum quantity of uplink MIMO layers, or a second maximum quantity of uplink analog beams.

Aspect 15: The method of any of aspects 1 through 14, wherein the indication specifies at least one set of one or more antenna panels that are not to be used for the multi-panel communication.

Aspect 16: The method of any of aspects 1 through 15, wherein the indication specifies at least one minimum time gap between transmissions associated with the multi-panel communication.

Aspect 17: The method of aspect 16, wherein the at least one minimum time gap comprises at least one of: a first minimum time gap between a first downlink transmission associated with the first antenna panel and a second downlink transmission associated with the second antenna panel; or a second minimum time gap between a first uplink transmission associated with the first antenna panel and a second uplink transmission associated with the second antenna panel.

Aspect 18: The method of aspect 16, wherein the at least one minimum time gap comprises at least one of: a first minimum time gap between a first downlink transmission associated with the first antenna panel and a first uplink transmission associated with the second antenna panel; or a second minimum time gap between a second uplink transmission associated with the first antenna panel and a second downlink transmission associated with the second antenna panel.

Aspect 19: The method of aspect 16, wherein the at least one minimum time gap comprises at least one of: a first minimum time gap between a first downlink control information transmission associated with the first antenna panel and a first data transmission associated with the second antenna panel, wherein the first downlink control information schedules the first data transmission; or a second minimum time gap between a second downlink control information transmission associated with the second antenna panel and a second data transmission associated with the first antenna panel, wherein the second downlink control information schedules the second data transmission.

Aspect 20: The method of aspect 16, wherein the at least one minimum time gap comprises at least one of: a first minimum time gap between a first downlink transmission associated with the first antenna panel and a first acknowledgment transmission associated with the second antenna panel, wherein the first acknowledgment transmission is associated with the first downlink transmission; or a second minimum time gap between a second downlink transmission associated with the second antenna panel and a second acknowledgment transmission associated with the first antenna panel, wherein the second acknowledgment transmission is associated with the second downlink transmission.

Aspect 21: The method of aspect 16, wherein the at least one minimum time gap comprises: a first time gap associated with the first antenna panel; and a second time gap associated with the second antenna panel, wherein the second time gap is different from the first time gap.

Aspect 22: The method of any of aspects 1 through 21, wherein the indication is output for transmission to the network entity via at least one of: uplink control information, a medium access control-control element (MAC-CE), or a radio resource control (RRC) message.

Aspect 23: The method of any of aspects 1 through 22, further comprising: transmitting the indication; and transmitting the request, wherein the first apparatus is configured as a user equipment.

Aspect 25: A method for communication at a first apparatus, the method comprising: obtaining an indication of a first antenna panel and a second antenna panel that are available for a multi-panel communication with a first user equipment, the first antenna panel being associated with the first user equipment and the second antenna panel being associated with a second user equipment; and communicating first data and second data for the multi-panel communication, the first data being communicated between the first antenna panel and a first transmit receive point, the second data being communicated between the second antenna panel and a second transmit receive point.

Aspect 26: The method of aspect 25, further comprising: scheduling a simultaneous transmission or reception for the first user equipment based on the first antenna panel and the second antenna panel being available for the multi-panel communication.

Aspect 27: The method of any of aspects 25 through 26, further comprising: configuring the first transmit receive point to transmit to or receive from the first antenna panel for the multi-panel communication; and configuring the second transmit receive point to transmit to or receive from the second antenna panel for the multi-panel communication.

Aspect 28: The method of any of aspects 25 through 27, wherein the indication specifies at least one of: a first configuration associated with the first antenna panel and a second configuration associated with the second antenna panel, a quantity of antenna panels associated with the second user equipment, a first identifier associated with the first antenna panel and a second identifier associated with the second antenna panel, or at least one third antenna panel that will not be used for the multi-panel communication.

Aspect 29: The method of any of aspects 25 through 28, wherein: the indication specifies at least one minimum time gap between transmissions for the multi-panel communication; and the method further comprises scheduling a multi-panel transmission or reception for the first user equipment based on the at least one minimum time gap.

Aspect 30: The method of any of aspects 25 through 29, further comprising: receiving the indication; and transmitting or receiving the first data and the second data, wherein the first apparatus is configured as a network entity.

Aspect 31: A user equipment, comprising: at least one transceiver; a memory comprising instructions; and one or more processors configured to execute the instructions and cause the user equipment to perform a method in accordance with any one or more of aspects 1-22, wherein the at least one transceiver is configured to transmit the fourth signal.

Aspect 32: A first apparatus configured for communication comprising at least one means for performing any one or more of aspects 1 through 23.

Aspect 33: A non-transitory computer-readable medium storing computer-executable code, comprising code for causing a first apparatus to perform any one or more of aspects 1 through 23.

Aspect 34: A network entity, comprising: at least one transceiver; a memory comprising instructions; and one or more processors configured to execute the instructions and cause the network entity to perform a method in accordance with any one or more of aspects 25-29, wherein the at least one transceiver is configured to receive the first signal.

Aspect 35: A first apparatus configured for communication comprising at least one means for performing any one or more of aspects 25 through 30.

Aspect 36: A non-transitory computer-readable medium storing computer-executable code, comprising code for causing a first apparatus to perform any one or more of aspects 25 through 30.

Aspect 37: A first apparatus, comprising: a memory comprising instructions; and one or more processors configured to execute the instructions and cause the first apparatus to perform a method in accordance with any one or more of aspects 1-22.

Aspect 38: A first apparatus, comprising: a memory comprising instructions; and one or more processors configured to execute the instructions and cause the first apparatus to perform a method in accordance with any one or more of aspects 25-29.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-3, 5-8, 10-13, and 15 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first apparatus for communication, comprising:
an interface; and
a processing system coupled to the interface, wherein the processing system is configured to:
generate an indication of a first antenna panel and a second antenna panel that are available for a multi-panel communication with the first apparatus, the first antenna panel being associated with the first apparatus and the second antenna panel being associated with a second apparatus;
output the indication via the interface for transmission to a network entity; and
output, via the interface for transmission to the second apparatus, a request for the second apparatus to perform a forwarding operation between the first apparatus and the second antenna panel.

2. The first apparatus of claim 1, wherein the request comprises a sidelink message.

3. The first apparatus of claim 1, wherein the processing system is further configured to:
obtain, via the interface, first data of the multi-panel communication that is received via the first antenna panel; and
obtain, via the interface, second data of the multi-panel communication that is received from the second apparatus.

4. The first apparatus of claim 3, wherein:
the first data is obtained from a transmit receive point; and
the second data is obtained via a sidelink established between the first apparatus and the second apparatus.

5. The first apparatus of claim 1, wherein the processing system is further configured to:
output, via the interface for transmission via the first antenna panel, first data of the multi-panel communication; and
output, via the interface for transmission to the second apparatus, second data of the multi-panel communication.

6. The first apparatus of claim 5, wherein:
the first data is output for transmission to a transmit receive point; and
the second data is output for transmission via a sidelink established between the first apparatus and the second apparatus.

7. The first apparatus of claim 1, wherein the processing system is further configured to:
obtain, via the interface, first data of the multi-panel communication that was received via the first antenna panel, and output, via the interface for transmission to the second apparatus, second data of the multi-panel communication; or
output, via the interface for transmission via the first antenna panel, third data of the multi-panel communication, and obtain, via the interface, fourth data of the multi-panel communication that was received from the second apparatus.

8. The first apparatus of claim 1, wherein the indication comprises a first configuration associated with the first antenna panel and a second configuration associated with the second antenna panel.

9. The first apparatus of claim 1, wherein the indication specifies a quantity of antenna panels associated with the second apparatus.

10. The first apparatus of claim 1, wherein the indication comprises a first identifier associated with the first antenna panel and a second identifier associated with the second antenna panel.

11. The first apparatus of claim 1, wherein the indication identifies at least one third antenna panel that will not be used for the multi-panel communication.

12. The first apparatus of claim 1, wherein the indication specifies whether:
the first antenna panel is available for downlink transmission only, uplink transmissions only, or both uplink transmissions and downlink transmissions; and
the second antenna panel is available for downlink transmission only, uplink transmissions only, or both uplink transmissions and downlink transmissions.

13. The first apparatus of claim 1, wherein the indication specifies at least one of:
for the first antenna panel, a first maximum quantity of downlink multiple-input multiple-output (MIMO) layers, a first maximum quantity of downlink demodulation reference signal (DMRS) ports, a first maximum quantity of channel state information-reference signal (CSI-RS) ports per CSI-RS resource for channel state feedback (CSF), or a first maximum quantity of downlink analog beams; and
for the second antenna panel, a second maximum quantity of downlink MIMO layers, a second maximum quantity of downlink DMRS ports, a second maximum quantity of CSI-RS ports per CSI-RS resource for CSF, or a second maximum quantity of downlink analog beams.

14. The first apparatus of claim 1, wherein the indication specifies at least one of:
for the first antenna panel, a first maximum quantity of uplink antenna ports, a first maximum quantity of uplink multiple-input multiple-output (MIMO) layers, or a first maximum quantity of uplink analog beams; and
for the second antenna panel, a second maximum quantity of uplink antenna ports, a second maximum quantity of uplink MIMO layers, or a second maximum quantity of uplink analog beams.

15. The first apparatus of claim 1, wherein the indication specifies at least one set of one or more antenna panels that are not to be used for the multi-panel communication.

16. The first apparatus of claim 1, wherein the indication specifies at least one minimum time gap between transmissions associated with the multi-panel communication.

17. The first apparatus of claim 16, wherein the at least one minimum time gap comprises at least one of:
a first minimum time gap between a first downlink transmission associated with the first antenna panel and a second downlink transmission associated with the second antenna panel; or
a second minimum time gap between a first uplink transmission associated with the first antenna panel and a second uplink transmission associated with the second antenna panel.

18. The first apparatus of claim 16, wherein the at least one minimum time gap comprises at least one of:
a first minimum time gap between a first downlink transmission associated with the first antenna panel and a first uplink transmission associated with the second antenna panel; or
a second minimum time gap between a second uplink transmission associated with the first antenna panel and a second downlink transmission associated with the second antenna panel.

19. The first apparatus of claim 16, wherein the at least one minimum time gap comprises at least one of:
a first minimum time gap between a first downlink control information transmission associated with the first antenna panel and a first data transmission associated with the second antenna panel, wherein the first downlink control information schedules the first data transmission; or
a second minimum time gap between a second downlink control information transmission associated with the second antenna panel and a second data transmission associated with the first antenna panel, wherein the second downlink control information schedules the second data transmission.

20. The first apparatus of claim 16, wherein the at least one minimum time gap comprises at least one of:
a first minimum time gap between a first downlink transmission associated with the first antenna panel and a first acknowledgment transmission associated with the second antenna panel, wherein the first acknowledgment transmission is associated with the first downlink transmission; or
a second minimum time gap between a second downlink transmission associated with the second antenna panel and a second acknowledgment transmission associated with the first antenna panel, wherein the second acknowledgment transmission is associated with the second downlink transmission.

21. The first apparatus of claim 16, wherein the at least one minimum time gap comprises:
a first time gap associated with the first antenna panel; and
a second time gap associated with the second antenna panel, wherein the second time gap is different from the first time gap.

22. The first apparatus of claim 1, wherein the indication is output for transmission to the network entity via at least one of: uplink control information, a medium access control-control element (MAC-CE), or a radio resource control (RRC) message.

23. The first apparatus of claim 1, further comprising:
a transmitter configured to transmit the indication and the request,
wherein the first apparatus is configured as a user equipment.

24. A method for communication at a first apparatus, the method comprising:
generating an indication of a first antenna panel and a second antenna panel that are available for a multi-panel communication with the first apparatus, the first antenna panel being associated with the first apparatus and the second antenna panel being associated with a second apparatus;
outputting the indication for transmission to a network entity; and
outputting, for transmission to the second apparatus, a request for the second apparatus to perform a forwarding operation between the first apparatus and the second antenna panel.

25. A first apparatus for communication, comprising:
an interface; and
a processing system coupled to the interface, wherein the processing system is configured to:
obtain, via the interface, an indication of a first antenna panel and a second antenna panel that are available for a multi-panel communication with a first user equipment, the first antenna panel being associated with the first user equipment and the second antenna panel being associated with a second user equipment; and
communicate, via the interface, first data and second data for the multi-panel communication, the first data being communicated between the first antenna panel and a first transmit receive point, the second data being communicated between the second antenna panel and a second transmit receive point.

26. The first apparatus of claim 25, wherein the processing system is further configured to:
schedule a simultaneous transmission or reception for the first user equipment based on the first antenna panel and the second antenna panel being available for the multi-panel communication.

27. The first apparatus of claim 25, wherein the processing system is further configured to:
configure the first transmit receive point to transmit to or receive from the first antenna panel for the multi-panel communication; and
configure the second transmit receive point to transmit to or receive from the second antenna panel for the multi-panel communication.

28. The first apparatus of claim 25, wherein the indication specifies at least one of: a first configuration associated with the first antenna panel and a second configuration associated with the second antenna panel, a quantity of antenna panels associated with the second user equipment, a first identifier associated with the first antenna panel and a second identifier associated with the second antenna panel, or at least one third antenna panel that will not be used for the multi-panel communication.

29. The first apparatus of claim 25, wherein:
the indication specifies at least one minimum time gap between transmissions for the multi-panel communication; and
the processing system is further configured to schedule a multi-panel transmission or reception for the first user equipment based on the at least one minimum time gap.

30. The first apparatus of claim 25, further comprising:
a transceiver configured to receive the indication and to transmit or receive the first data and the second data,
wherein the first apparatus is configured as a network entity.
